(19) United States
(12) Patent Application Publication
(10) Pub. No.: US 2023/0347468 A1
(43) Pub. Date: Nov. 2, 2023

(54) Optical Machine for Treatment and/or Processing Optical Workpieces, such as Ophthalmic Lenses, and Deblocking Apparatus and Deblocking Method for Same

(71) Applicant: Satisloh AG, Baar (CH)

(72) Inventors: Holger Schäfer, Weilmünster (DE); Steffen Wallendorf, Wetzlar-Dutenhofen (DE); Martin Lautz, Wetzlar-Nauborn (DE); Gregor Pavel, Hüttenberg (DE)

(21) Appl. No.: 17/761,148

(22) PCT Filed: Sep. 7, 2020
(86) PCT No.: PCT/EP2020/000151

§ 371 Date: Mar. 16, 2022

(30) Foreign Application Priority Data
Sep. 16, 2019 (DE) 10 2019 006 504.2

(51) Int. Cl. B24B 13/005; B29D 11/00; B24B 9/14; B24B 13/00

(52) U.S. Cl. CPC B24B 13/0057; B29D 11/00423; B24B 9/146; B24B 13/0031

(57) ABSTRACT

An optical machine (AV) for treatment and/or processing optical workpieces (L) has a machine frame (MG) on which a workpiece holding arrangement (WH) is movably supported and at least two treatment and/or processing devices (DB1, DB2, DB3) for treatment and/or processing a workpiece. The workpiece holding arrangement has a plurality of partition walls (TW) which separate and delimit at least three work spaces (AR1, AR2, AR3, AR4) from one another. The work spaces can be moved, together with the workpiece holding arrangement.

To each work space, a workpiece holder (CH) is assigned for the purpose of parallel use of the work spaces. Each work space can be moved, together with the workpiece holding arrangement, with respect to the machine frame in a movement cycle from a loading station (PS) on the machine frame, via stationary treatment and/or processing stations (DS, CS) which are spatially distanced from the loading station.

### TECHNICAL FIELD

The present invention relates generally to an optical machine for treatment and/or processing of optical workpieces, such as spectacle lenses, according to the preamble portion of claim 1. In particular, the invention relates to a deblocking device as well as to a method for deblocking such workpieces from associated block pieces, in correspondence with claims 15 and 24, respectively, such as are widely employed in modern “RX workshops”, i.e. industrial production facilities for production of individual spectacle lenses according to prescription.

### STATE OF THE ART

In optical production, “blocking-on” or, for short, “blocking” generally denotes the procedure in which an optical workpiece is temporarily fastened with the aid of a suitable material (alloyed material of low melting point—so-called “alloy”—or adhesive) on a so-called “block piece” or, however, the blocking material is coated on the workpiece so as to itself form the block piece, which then serves the purpose of holding the workpiece in the respective processing machine and/or coating system.

Spectacle lenses are blocked on a large scale in the afore-mentioned RX workshops before each blocked spectacle lens is then processed by material removal with geometrically defined cutting (milling/turning) or geometrically undefined cutting (grinding/polishing) at its back surface or front surface with respect to its optical effect and/or at the edge for fitting in an associated spectacle frame and/or is coated on its back surface or front surface for achieving additional effects (increase in scratch resistance, anti-reflection properties, vapor deposition, hydrophobic properties, etc.).

When in the following in connection with the present invention mention is made in general of “spectacle lenses” as preferred field of use there are to be understood by that optical lenses or lens preforms (blanks) for spectacles of customary materials such as polycarbonate, mineral glass, CR 39, HI-index, etc., which may have any (preliminary) shape of the circumferential edge of the lens or lens blank and which prior to blocking may—but do not have to—have already undergone (preliminary) processing and/or (preliminary) coating at one optically effective surface or both optically effective surfaces and/or at the edge. In addition, the spectacle lens can be provided on its surface, at which it is or is to be blocked, with a film, a lacquer or the like so as to protect this surface from contamination and damage and/or to improve the adhesion characteristics between spectacle lens and blocking material, without this being specifically mentioned on each occasion in the following.

In optical production, by contrast to “blocking” that process in which the optical workpiece after (final) processing thereof (at surface and/or edge) and/or coating thereof is again separated from the block piece/blocking material is called “deblocking”. For the deblocking of spectacle lenses, a pressure medium such as water is usually used in the prior art to detach the spectacle lens from the block piece by application of hydraulic forces. In that regard, a technological approach has become established in which the application of hydraulic forces takes place from “outside” and, in particular, by a high-pressure water jet, which is delivered by a nozzle and impinges on an edge location between block piece and spectacle lens (for example WO 2008/003805 A1, FIG. 1, water jet 7; DE 10 2009 048 590 A1, FIG. 5, high-pressure water jet HDS; DE 10 2010 010 334 Al, FIG. 6, high-pressure water jet H).

In general, prior art optical machines for the treatment and/or processing of optical workpieces such as spectacle lenses usually have a holding arrangement, which is mounted on a machine frame, for the optical workpiece and at least one, optionally even several, treatment and/or processing devices, which are mounted on the machine frame, for treatment and/or processing of the optical workpiece, which is held in the workpiece holding arrangement, in a work space, in which case a relative movement between the workpiece holding arrangement and the respective treatment and/or processing device is possible particularly for the treatment and/or processing of the optical workpiece in the work space.

For the specific case of deblocking of optical workpieces, such as spectacle lenses, from associated block pieces, document DE 10 2009 048 590 A1, for example, discloses a deblocking device comprising a first movement device (motor spindle with clamping chuck) for rotation of the spectacle lens, which is blocked on a block piece, about a workpiece axis of rotation as a component of a workpiece holding arrangement of the deblocking device, a nozzle subassembly with a nozzle for delivery of a high-pressure water jet in a direction substantially transverse to the workpiece axis of rotation onto an edge region between spectacle lens and block piece as a first treatment device of the deblocking device, and a second movement device for producing a relative movement between the spectacle lens and the nozzle along the workpiece axis of rotation.

In that case, the spectacle lens can be displaced with respect to the nozzle—or conversely the nozzle with respect to the spectacle lens—by the second movement device along the workpiece axis of rotation under positional regulation so that the high-pressure water jet is directed onto a predetermined point of incidence in the edge region between spectacle lens and block piece. As a result, the high-pressure water jet does not impinge more or less randomly on the separating point between block piece and blocking material or the separating point between blocking material and spectacle lens, but as a consequence of the relative (height) adjustability of nozzle and block piece can be directed under CNC targeting onto the respective separating point, which enables rapid deblocking and makes this device particularly suitable for use in RX workshops.

Moreover, in the case of this prior art there can be provided, for cleaning the deblocked spectacle lens, a further nozzle for delivery of a further, rotating high-pressure jet as a second treatment device of the deblocking device, which serves the purpose of, in particular, “peeling off” from the spectacle lens any blocking material which might still adhere to the deblocked spectacle lens. A suction device with a suction head serving the purpose of holding the spectacle lens at an end surface thereof during deblocking from the block piece forms a further component of the workpiece holding arrangement in this prior art deblocking device.

Finally and starting from this state of the art, document DE 10 2017 001 679 A1, which forms the preamble portion of claim 1, discloses a device for deblocking a lens from a block piece on which the lens is blocked with the aid of a blocking material, wherein a blocking side of the lens is optionally provided with a protective coating or protective film. This prior art device generally comprises a work space, a first holding device for rotational holding of the lens in the work space, a second holding device for rotational holding of the block piece in the work space and a plurality of nozzle devices for delivery of fluid jets in the work space.

In an endeavor to make possible a rapid deblocking with high throughput, it is proposed in this prior art, inter alia, to provide three nozzle devices for generating a first, a second and an additional fluid jet in the work space, wherein the first fluid jet can be used for detaching the lens together with the protective layer—insofar as present—from the blocking material, the second fluid jet for removal of blocking material from the block piece and the additional fluid jet for removal of the protective layer and/or blocking material from the lens.

Whereas in this prior art the second holding device for rotational holding of the block piece in a predetermined relative position with respect to the three nozzle devices is arranged in a fixed location in the work space, the first holding device for rotational holding of the lens in the work space can be pivoted together with the deblocked lens out of the work space, i.e. pivoted away from the deblocked block piece. As a result, the deblocking device of this configuration enables placing of the lens, which is blocked on the block piece, in the work space, deblocking of the lens from the block piece in the work space, cleaning of the deblocked lens and the deblocked block piece in the work space, removal of the deblocked lens from the work space and removal of the deblocked block piece from the work space in a sequential succession. However, a higher throughput in the deblocking of a multiplicity of lenses, such as takes place in RX workshops, would be desirable.

### OBJECT

The invention specifically has the object of providing a deblocking device and a method for deblocking optical workpieces, particularly spectacle lenses, from associated block pieces, which device and method enable fastest possible deblocking of workpieces. In general, the invention has the object of creating an optical machine for the treatment and/or processing of optical workpieces, particularly spectacle lenses, by which a highest possible throughput of workpieces is achievable in an industrial production environment.

### ILLUSTRATION OF THE INVENTION

This object is fulfilled generally by an optical machine for treatment and/or processing of optical workpieces, such as spectacle lenses, with the features of claim 1 or specifically by a deblocking device and a method for deblocking of optical workpieces, such as spectacle lenses, from associated block pieces with the features of claims 15 and 24, respectively. Advantageous embodiments of the invention are the subject of the subclaims.

According to the invention, in an optical machine for the treatment and/or processing of optical workpieces, particularly spectacle lenses, comprising a machine frame, a workpiece holding arrangement movably mounted on the machine frame and at least two treatment and/or processing devices, which are mounted on the machine frame, for treatment and/or processing of an optical workpiece held in the workpiece holding arrangement, the workpiece holding arrangement comprises a plurality of partition walls which mutually separate and delimit at least three work spaces, with each of which there is associated—for parallel use for different optical workpieces—a respective workpiece holder, wherein the work spaces together with the workpiece holding arrangement are movable with respect to the machine frame so that each work space is selectably displaceable from a loading station, which has a fixed location at the machine frame, for the optical workpiece to the treatment and/or processing stations, which are three-dimensionally spaced from the loading station and which comprise treatment and/or processing devices, and conversely.

According to the invention, in the case of, especially, a deblocking device for deblocking of optical workpieces, particularly spectacle lenses, from associated block pieces, comprising a loading station for loading optical workpieces, which are blocked on block pieces, prior to deblocking and/or unloading of deblocked optical workpieces and/or of block pieces after the deblocking, a deblocking station as treatment station for the deblocking of optical workpieces from the respectively associated block piece and a cleaning station as treatment station for the cleaning of the deblocked workpieces and/or the block pieces, each work space is displaceable together with the workpiece holding arrangement in a movement cycle from the loading station via the deblocking station and the cleaning station to the loading station so that the work spaces are simultaneously usable for different optical workpieces and different processes.

With respect to method, according to the invention in a method for the deblocking of optical workpieces, particularly spectacle lenses, from associated block pieces and comprising the following steps: i) placing an optical workpiece, which is blocked on a block piece, in a deblocking device as a first handling step, ii) deblocking the optical workpiece from the block piece in the deblocking device, iii) removing the deblocked optical workpiece from the deblocking device as a second handling step and iv) removing or taking out the block piece, which is separated from the optical workpiece, from the deblocking device as a third handling step, it is further provided that the above deblocking step ii) and at least one of the above handling steps i), iii) and iv) are performed simultaneously for different optical workpieces or block pieces and/or that after the deblocking step ii) and prior to the handling step iii) and/or iv) the deblocked optical workpiece and/or the block piece is or are subjected to a cleaning step v), wherein the cleaning step v) and at least the deblocking step ii) are performed simultaneously for different optical workpieces or block pieces.

In essence, in terms of device the present invention is thus based on providing a workpiece holding arrangement which is movable relative to the stationary machine frame of the respective optical machine and the special feature of which resides in the fact that in its physical form it defines a plurality of work spaces in which several optical workpieces can be subjected to treatment and/or processing simultaneously at a plurality of treatment and/or processing stations distributed at the machine frame. Parallel therewith in time it is possible for a work space, in which no treatment and/or processing of the optical workpieces is or are carried out, to be loaded at the loading station, which is similarly arranged at the machine frame and which is physically separate from the treatment and/or processing stations, with new optical workpieces or for already handled and/or processed optical workpieces to be unloaded. In that case, each work space of the workpiece holding arrangement is movable from station to station and equipped at least with a workpiece holder, i.e. the work spaces physically separated from one another are thus to that extent configured to be the same so that each work space can be employed at each of the stations (loading station, treatment and/or processing stations).

Thus, for example in the case of the afore-described deblocking device, a first optical workpiece blocked on a block piece can be loaded at the loading station into a work space of the workpiece holding arrangement and/or a deblocked second optical workpiece and/or a deblocked block piece unloaded at the loading station from a work space of the workpiece holding arrangement at the same time, whilst a third optical workpiece is deblocked from the associated block piece in a work space, which is present at the deblocking station, of the workpiece holding arrangement and a fourth optical workpiece is cleaned in a work space, which is present at the cleaning station, of the workpiece holding arrangement. Each individual optical workpiece in that case sequentially runs through the individual process steps, which, however, elapse simultaneously for different optical workpieces.

Such an embodiment of the deblocking device also allows performance of the method according to the invention, which in essence is based on performing at least the deblocking step ii) simultaneously with at least one of the handling steps i), iii) and iv) and/or the cleaning step v) for different optical workpieces or block pieces, so that at least two process steps elapse parallely in time during the deblocking. By comparison with the prior art outlined in the introduction, in which it is not possible to perform further process steps during the deblocking, this already enables a substantial increase in throughput of optical workpieces. If in addition to the deblocking step ii) even two or more further process steps are executed simultaneously, the throughput can be further significantly increased. This high level of throughput performance makes the optical machine according to the invention and the deblocking method according to the invention suitable for use in an industrial production environment in which a very large number of optical workpieces for treatment or processing arises.

Apart from the use of this optical machine concept for the deblocking of optical workpieces from associated block pieces, other applications in optical production in which different optical workpieces undergo at least two treatment and/or processing steps are, of course, also conceivable. Thus, the optical machine according to the invention can find use for, for example, preliminary edging (cribbing) of optical lenses, particularly spectacle lenses. Such an optical machine then has—apart from the loading station for loading optical lenses which are to undergo (preliminary) edging or for unloading optical lenses which have undergone (preliminary) edging—for example at least two physically mutually separate processing stations with associated processing devices in which a first material-removing edge processing step or a second material-removing edge processing step takes place. The first material-removing edge processing step can serve for, for example, diameter reduction of a round spectacle lens blank, whereas the second material-removing edge processing step is provided for, for example, a first shape adaptation of the edge contour of the spectacle lens blank to a shape, which departs from a circular shape, in approximation to the later finished shape of the spectacle lens, and/or for edge refraction at the spectacle lens blank. These process steps can elapse parallely in time for different optical workpieces with the optical machine concept according to the invention without the optical workpieces having to be unchucked, so that a very high level of throughput is achievable. The gains in time and throughput which can be realized with the optical machine concept according to the invention by comparison with the prior art optical machines are maximized if the individual process steps are of substantially equal length, so that no or hardly any dead times, in which no treatment and/or processing of the optical workpieces takes or take place, arise at the individual treatment and/or processing stations.

If in the case of one of the treatment and/or processing steps in the respective treatment and/or processing stations a relative movement between the optical workpiece and the respective treatment and/or processing device is desirable or necessary then provision can be made for the workpiece holders of the workpiece holding arrangement to be mounted to each be rotatable about its longitudinal axis so as to enable this relative movement in the simplest possible manner. However, alternatively thereto the workpiece holders of the workpiece holding arrangement can also be constructed to be stationary with respect to the respective work space if the respective treatment and/or processing device is capable of generating the relative movement with respect to the optical workpiece, for example by “going around” the optical workpiece held at the respective workpiece holder.

In a preferred embodiment of the optical machine, the workpiece holding arrangement of which comprises rotatable workpiece holders, the workpiece holders are drivable for selectable rotation about the longitudinal axis thereof, for which purpose there is associated with at least one of the treatment and/or processing stations a rotary drive which is mounted on the machine frame and drivingly connectible by a clutch with that workpiece holder which is present in the respective treatment and/or processing station. Thus, only those treatment and/or processing stations at which a rotational movement of the workpiece holder is necessary or desirable in correspondence with the relevant treatment or processing requirements are equipped with a rotary drive, which is fixed in location, for the workpiece holders. In principle, it is certainly also possible to provide an individual rotary drive for each workpiece holder, but such an embodiment of the optical machine would be incomparably more expensive, because the rotary drives would have to move in company with the work spaces—which in a given case would also oblige complex conducting of energy—and an individual rotary drive would even have to be allocated to each work space.

Fundamentally, it is conceivable to move the individual work spaces of the optical machine in, for example, a square arrangement with associated linear movement axes, a chain circulation or the like. By contrast, however, it is preferred to construct the optical machine so that the work spaces of the workpiece holding arrangement together with the workpiece holders thereof are arranged to be rotatable about a common axis of rotation. This allows a very compact construction of the optical machine with advantageously short paths for the movement of the work spaces and additionally facilitates precise positioning of the work spaces at the respective treatment and/or processing station, also because the individual components associated with the work spaces, such as, for example, the workpiece holders, remain in their position with respect to the axis of rotation. It is then merely necessary to provide an angle transducer at the axis of rotation for precise positioning of the work spaces.

In further pursuance of the concept of the invention provision can be made for the workpiece holding arrangement to be of drum-like construction, with two mutually opposite end walls between which the partition walls separating the work spaces are arranged, wherein the axis of rotation runs through the end walls. Alternatively thereto a turntable arrangement is conceivable with workpiece holders, which are uniformly angularly spaced about the axis of rotation, on an end face of the turntable. However, by contrast the drum arrangement offers, inter alia, the advantage that the separation or bounding of the individual work spaces by the partition walls between the end walls is simpler to execute. In an expedient embodiment of such a drum arrangement it can be provided that a first end wall of the workpiece holding arrangement carries the workpiece holders.

In correspondence with the respective treatment or processing requirements the optical machine can, moreover, be designed in such a way that a second end wall of the workpiece holding arrangement of drum-like construction carries workpiece counter-holders aligned with the workpiece holders. Thus, for example, it is possible in simple manner to secure the optical workpieces by counter-holders in the respective work space during the respective treatment and/or processing, which is not possible in the case of an equally conceivable “cantilever” mounting, i.e. at one end, of the optical workpieces at the workpiece holders.

In a preferred embodiment of the optical machine the workpiece counter-holders of the workpiece holding arrangement are mounted to be rotatable about the respective longitudinal axis thereof. In particular, it is then also possible to provide for the workpiece counter-holders of the workpiece holding arrangement to be selectably drivable for rotation about the longitudinal axis thereof, for which purpose there is associated with at least one of the treatment and/or processing stations a rotary drive which is mounted on the machine frame and drivingly connectible by a clutch with that workpiece counter-holder which is present in the respective treatment and/or processing station. The above explanations with respect to the preferred rotary design and arrangement of the workpiece holders and the rotary drive or drives thereof are applicable here in corresponding manner.

Moreover, the workpiece counter-holders of the workpiece holding arrangement can each be axially displaceable along the longitudinal axis thereof parallel to the axis of rotation in correspondence with the respective treatment or processing requirements. As an alternative (or addition) thereto, the workpiece holders of the workpiece holding arrangement can (also) each be axially displaceable along the longitudinal axis thereof parallel to the axis of rotation. However, this is less preferred particularly with regard to the stability of the arrangement.

In a concrete embodiment with respect thereto provision is preferably made for the workpiece counter-holders of the workpiece holding arrangement to be axially displaceable independently of one another by a respectively associated pneumatic cylinder. In principle, it is, in fact, also possible to produce the axial movements of the workpiece counter-holders by, for example, electric drives. However, this would be connected with a higher cost, particularly if the workpiece counter-holders are also constructed to be rotatable. The provision of pneumatic cylinders additionally offers the advantage—apart from a comparatively small requirement for installation space—that a constant force is available over the entire stroke of the pneumatic cylinder, which is conducive to fine sensitivity of the respective axial movement.

Moreover, the workpiece counter-holders of the workpiece holding arrangement can each be provided at the end thereof projecting into the respective work space with a suction head for holding the optical workpiece. It is indeed also possible to provide a gripper as an alternative to the suction head, but this presupposes that the edge of the optical workpiece to be gripped is not covered. By contrast, the suction head advantageously allows engagement with an end surface of the optical workpiece. Furthermore, a suction head is advantageously light and may not have any mechanically movable elements subject to wear or requiring maintenance.

Sofar as the conducting of energy to the pneumatic components to the extent described is concerned, it can be further provided that a pneumatic supply of the pneumatic cylinders and/or suction heads, which are rotatable together with the second end wall about the axis of rotation, for the workpiece counter-holders of the workpiece holding arrangement takes place by way of a common rotary joint, which is supported against rotation relative to the machine frame. In a particularly simple, compact and service-friendly arrangement the common rotary joint is preferably placed at the second end wall, near the workpiece counter-holders. However, the rotary joint can in principle also be seated at the first end wall or divided up, for the pneumatic cylinders and suction heads, between the two end walls, which, however, is less preferred particularly with regard to the outlay connected therewith.

With regard to transmission of torque from the respective rotary drive to the workpiece holders and/or the workpiece counter-holders it can be provided that the clutch is a mechanically positive clutch or a force-locking clutch depending on the relevant treatment or processing requirements. If in the respective treatment or processing the rotational angle of the optical workpiece held at the workpiece holder matters, then a mechanically positive clutch is provided, for example with—at the workpiece holder side—a sliding block which mechanically positively engages in a sliding groove of complementary shape of an entrainer provided at the rotary drive. On the other hand, if in the respective treatment or processing the rotational angle of the optical workpiece held at the workpiece holder does not matter, then, for example, a magnetic clutch with transmission of force across an air gap can be provided as a force-locking clutch.

If the afore-described machine concept is employed, for example, in a deblocking device for deblocking optical workpieces, namely spectacle lenses, from associated block pieces then it is preferred if the deblocking station of this deblocking device has, as first treatment device, a first nozzle subassembly with a first high-pressure nozzle for delivery of a high-pressure pressure medium jet for deblocking the optical workpieces from the respectively associated block piece. In principle, it is in fact also conceivable to mechanically deblock the optical workpieces from the associated block pieces, for example with the assistance of suitable cutting or the like, but this is less preferred particularly in view of process safety and good controllability of the deblocking process.

For fastest possible and most reliable possible deblocking by a high-pressure pressure medium jet, it is particularly preferred if the first high-pressure nozzle for delivery of the high-pressure pressure medium jet for deblocking of the optical workpieces from the respectively associated block piece is settable in situ in its axial position and/or its adjustment angle with respect to a blocked optical workpiece held in the deblocking station by the workpiece holding arrangement. By comparison with the possible alternative of a fluid-based deblocking without corresponding geometric setting possibilities at the high-pressure nozzle, the above setting possibility offers the advantage that during the deblocking process the high-pressure pressure medium jet can be directed or appropriately tracked in targeted manner to a specific point between workpiece and block piece so as to accelerate the deblocking.

Further, in the case of use of the afore-described machine concept in a deblocking device the above statement with respect to the deblocking station correspondingly applies to the cleaning station of the deblocking device. Thus, for example, mechanical cleaning by, for example, brushes or cleaning by ultrasound can be carried out in the cleaning station. On the other hand, however, it is preferred if the cleaning station has, as second treatment device, a second nozzle sub-assembly with a second high-pressure nozzle for delivery of a high-pressure pressure medium jet for cleaning the deblocked workpieces and/or the block pieces. It is also particularly preferred for acceleration of the cleaning processes at workpiece and block piece if the cleaning station has, as third treatment device, a third nozzle sub-assembly with a third high-pressure nozzle for delivery of a high-pressure pressure medium jet for cleaning the block pieces and/or the deblocked workpieces. The second high-pressure nozzle can thus be advantageously directed onto, for example, the deblocked workpiece whilst the third high-pressure nozzle targets the deblocked block piece, so that workpiece and block piece are cleaned simultaneously.

In a preferred embodiment of the deblocking device it is additionally provided that the loading station comprises a first sub-station for the loading of optical workpieces, which are blocked on block pieces, prior to the deblocking and for unloading of block pieces after the deblocking, as well as a second sub-station for unloading deblocked optical workpieces after the deblocking. By comparison with the possible alternative of a loading station without two sub-stations the above configuration of the deblocking device advantageously again allows parallelization of the processes, wherein, for example, unloading of a deblocked optical workpiece can take place simultaneously with unloading of a deblocked block piece or loading with a further optical workpiece in the blocked state.

In that regard, it is particularly preferred if the second sub-station for unloading of deblocked optical workpieces after the deblocking comprises a device, as further treatment device, for drying the deblocked optical workpieces. Then, if the above deblocking step ii) and/or the cleaning step v) takes or take place with the assistance of at least one high-pressure pressure medium jet, the deblocked optical workpiece can advantageously be simultaneously dried during the handling step iii), so that again different process steps are executed simultaneously.

For drying of the deblocked optical workpieces it is possible to, for example, pursue an approach in which centrifuging off of water drops by rotational drive of the handled optical workpiece or automatic wiping off of the optical workpiece by a suitable textile material is carried out. On the other hand, however, it is preferred particularly with respect to a high level of process security, namely a small risk of the deblocked optical workpiece experiencing damage during drying, if the device for drying of the deblocked optical workpieces comprises a workpiece gripper, by which a deblocked optical workpiece can be gripped, and at least one air nozzle, wherein the workpiece gripper and the air nozzle are movable relative to one another so that for the drying of a deblocked optical workpiece gripped by the workpiece gripper an air flow delivered by the air nozzle can be guided or wipes over the optical workpiece.

Finally, it is preferred, particularly with respect to a rapid succession of deblocking processes for multiple optical workpieces without the necessity of interrupting the machine running on occasion for maintenance and cleaning purposes, if there is associated with the deblocking station and/or the cleaning station at least one separate cleaning nozzle for delivery of a low-pressure pressure medium jet for cleaning of the respective station and/or if there is arranged below the deblocking station and the cleaning station a funnel-shaped housing section for collection in common of pressure medium, blocking material and other residues for preparation or disposal.

### BRIEF DESCRIPTION OF THE DRAWINGS

The invention is explained in more detail in the following on the basis of a preferred embodiment with reference to the accompanying, partly simplified or schematic drawings, which are not to scale and in which:

FIG. 1 shows a perspective view of a deblocking device according to the invention for the deblocking of optical workpieces, namely spectacle lenses, from associated block pieces, from obliquely above and front left, with a view onto a loading station for loading spectacle lenses, which are blocked on block pieces, prior to the deblocking and for unloading deblocked spectacle lenses and block pieces after the deblocking into and out of, respectively, work spaces of a central workpiece holding arrangement;

FIG. 2 shows a perspective view of the deblocking device according to FIG. 1 from obliquely above and front right;

FIG. 3 shows a similar perspective view, from the viewing angle of FIG. 2, of the deblocking device according to FIG. 1, wherein by comparison with the illustration in FIGS. 1 and 2 various components and subassemblies have been omitted so as to expose a view onto the workpiece holding arrangement, which is mounted in a machine frame and is of drum-like construction, with the loading and treatment stations (deblocking station, cleaning station) grouped therearound and a funnel-shaped housing section lying thereunder;

FIG. 4 shows a front view of the deblocking device according to FIG. 1 with the simplifications of FIG. 3;

FIG. 5 shows an upwardly broken-away sectional view of the deblocking device according to FIG. 1 in correspondence with the section line V-V in FIG. 4, with a view into four work spaces, which are separated by partition walls, of the workpiece holding arrangement of drum-like construction and onto the first end wall thereof, which carries four workpiece holders associated with the work spaces;

FIG. 6 shows a sectional view of the workpiece holding arrangement—separated from the machine frame—of the deblocking device according to FIG. 1 in correspondence with the section line VI-VI in FIG. 4;

FIG. 7 shows a perspective view of the workpiece holding arrangement—separated from the machine frame—and the funnel-shaped housing section, which lies thereunder, of the deblocking device according to FIG. 1 from obliquely above and front right, with a view onto a second end wall of the workpiece holding arrangement of drum-like construction and one of four workpiece counter-holders, which are mounted on the second end wall and which are respectively associated with the work spaces;

FIG. 8 shows a perspective view of the workpiece holding arrangement—separated from the machine frame—of the deblocking device according to FIG. 1 from obliquely above and front left, without the funnel-shaped housing section lying thereunder, with a view onto a side, which is remote from the work spaces, of the second end wall shown in FIG. 7 and a mounting arrangement, which is mounted thereon, for the workpiece counter-holders;

FIG. 9 shows a perspective view of the workpiece holding arrangement—separated from the machine frame—of the deblocking device according to FIG. 1 from obliquely above and back left, with a view onto a second sub-station of the loading station, which comprises a pivot mechanism with a workpiece gripper for unloading deblocked spectacle lenses, the pivot mechanism here being disposed in a position in which the workpiece gripper is pivoted into the work space opposite the second sub-station of the loading station;

FIG. 10 shows a perspective view, which corresponds with respect to the viewing angle of FIG. 9, of the workpiece holding arrangement—separated from the machine frame—of the deblocking device according to FIG. 1, wherein the workpiece gripper, which grips a spectacle lens, of the pivot mechanism is disposed in a position pivoted out of the work space so that the view onto a device for drying the deblocked and cleaned spectacle lens in the second sub-station of the loading station is exposed;

FIG. 11 shows a side view of the workpiece holding arrangement—separated from the machine frame—of the deblocking device according to FIG. 1 from the right in FIG. 4, with the simplifications of FIG. 8;

FIG. 12 shows a sectional view of the workpiece holding arrangement of the deblocking device according to FIG. 1 in correspondence with the angled section line XII-XII in FIG. 11, with a view into the deblocking station and the cleaning station of the deblocking device;

FIG. 13 shows a perspective view of the workpiece holding arrangement—separated from the machine frame—of the deblocking device according to FIG. 1 from obliquely below and back right, without a stationary housing for the workpiece holding arrangement, in particular for illustration of rotary drives for the workpiece holders at the first end wall, the workpiece counter-holders at the second end wall and the drum-like workpiece holding arrangement overall;

FIG. 14 shows a perspective view, which is broken away to the left, of the workpiece holding arrangement—separated from the machine frame—of the deblocking device according to FIG. 1 from obliquely above and front right, with a view onto a setting device for setting an axial position and an adjustment angle of a first high-pressure nozzle of the deblocking station;

FIG. 15 shows a perspective view of the separated setting device, which is shown in FIG. 14, for the first high-pressure nozzle of the deblocking station of the deblocking device according to FIG. 1 from obliquely above and front left;

FIG. 16 shows a perspective view of the separated setting device, which is shown in FIG. 15, for the first high-pressure nozzle of the deblocking station of the deblocking device according to FIG. 1 from obliquely below and back left;

FIG. 17 shows a perspective view of the workpiece holding arrangement—separated from the machine frame—of the deblocking device according to FIG. 1 from obliquely above and back left, without the stationary housing for the workpiece holding arrangement, in correspondence with the illustration in FIG. 13, with a view onto the side, which is remote from the work spaces, of the second end wall of the workpiece holding arrangement;

FIG. 18 shows a perspective view of the workpiece holding arrangement of the deblocking device according to FIG. 1 from obliquely above and front left, with the simplifications of FIG. 17, wherein the workpiece counter-holder is disposed in the second work space in a position moved out by an associated pneumatic cylinder;

FIG. 19 shows a perspective view of the second end wall of the workpiece holding arrangement of the deblocking device according to FIG. 1 from obliquely above and front left, wherein for reasons of better clarity merely one of four workpiece counter-holder subassemblies, which are mounted at the second end wall, is shown;

FIG. 20 shows a perspective view of the second end wall of the workpiece holding arrangement of the deblocking device according to FIG. 1 from obliquely above and front right, with the simplifications of FIG. 19;

FIG. 21 shows a side view of the second end wall of the workpiece holding arrangement of the deblocking device according to FIG. 1 from the left in FIG. 4, with the simplifications of FIG. 19;

FIG. 22 shows a sectional view of the second end wall of the workpiece holding arrangement of the deblocking device according to FIG. 1 in correspondence with the multiply angled section line XXII-XXII in FIG. 21, with the simplifications of FIG. 19; and

FIG. 23 shows a circuit diagram of a pneumatic supply for the pneumatic cylinders and suction heads for the workpiece counter-holders, which are provided at the second end wall of the workpiece holding arrangement of the deblocking device of FIG. 1.

With respect to the drawings it may also be noted at this point that the illustration of the deblocking device according to the invention is in a right-angled Cartesian co-ordinate system in which the letter x denotes the length direction, the letter y denotes the width direction and the letter z denotes the height direction of the deblocking device. In order to reveal a view of essential components or subassemblies of the deblocking device and for simplification of the illustration, parts of the cladding, the supply devices (inclusive of lines, hoses and pipes) for power, compressed air and water as pressure medium, the suction device as well as the measuring, maintenance and safety devices, in particular, have mostly been omitted in the drawings, since they do not appear necessary for an understanding of the invention and are in any case familiar to the expert.

### DETAILED DESCRIPTION OF THE EMBODIMENT

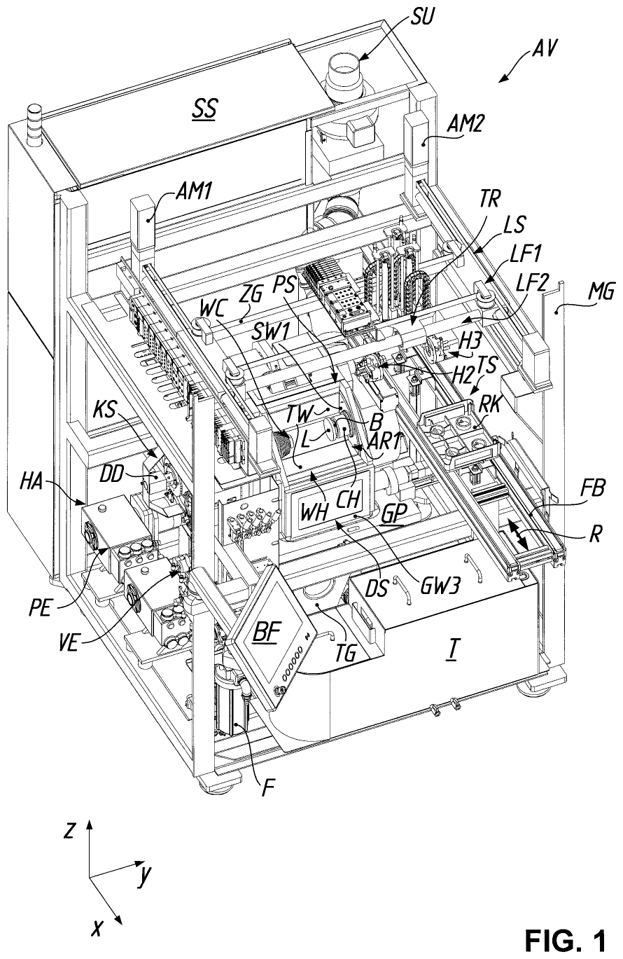

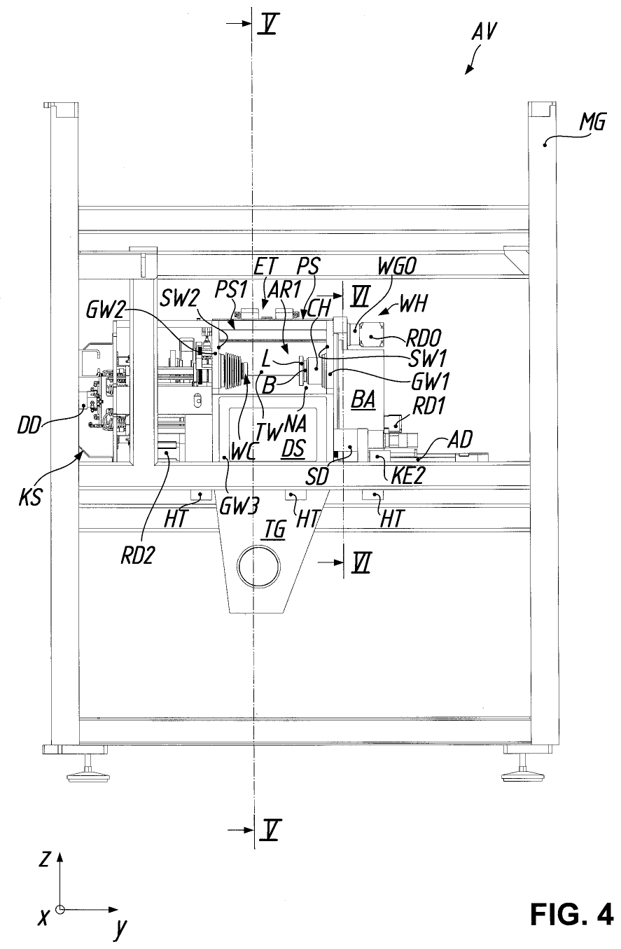

A deblocking device, for example for an optical machine for treatment and/or processing optical workpieces, for the deblocking of optical workpieces, such as spectacle lenses L, from associated block pieces B is generally denoted by the reference AV in FIGS. 1 to 5. The deblocking device AV comprises a machine frame MG, at which, as core element of the deblocking device AV, a specially constructed workpiece holding arrangement WH is movably mounted at a central point, the arrangement being described in more detail in the following.

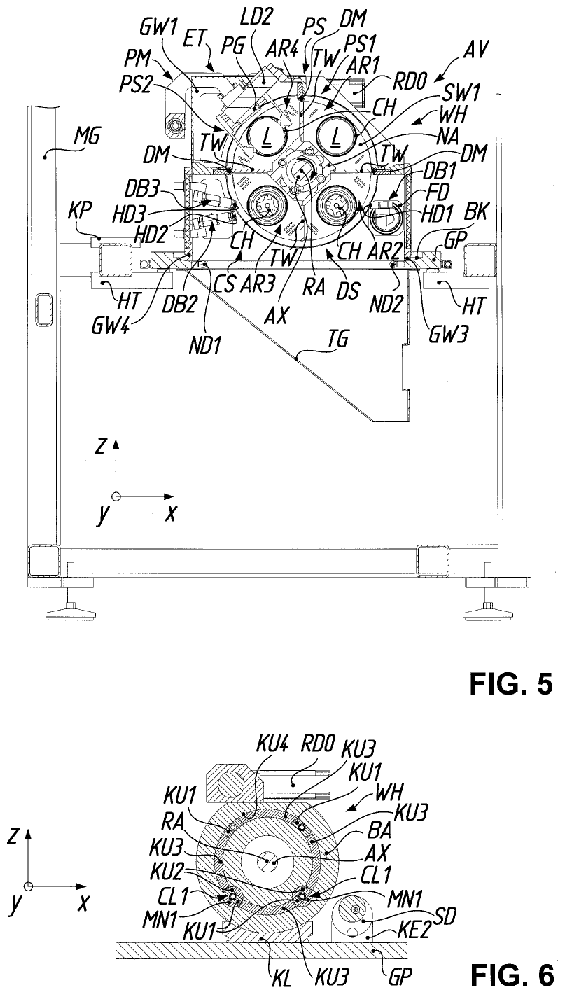

As can be seen particularly clearly in FIG. 5, different stations of the deblocking device AV are grouped in stationary position at the machine frame MG around the workpiece holding arrangement WH. These stations are, firstly, a loading station PS at the top, comprising a first sub-station PS1 (on the right in FIG. 5) for loading spectacle lenses L, which are blocked on block pieces B, prior to the deblocking and for unloading block pieces B after the deblocking as well as a second sub-station PS2 (on the left in FIG. 5) for unloading deblocked spectacle lenses L after the deblocking. Mounted on the machine frame MG at a three-dimensional spacing from the loading station PS are, below the loading station PS, a deblocking station DS (on the right in FIG. 5) as first treatment station for deblocking the spectacle lenses L from the respectively associated block piece B and a cleaning station CS (on the left in FIG. 5) as further treatment station for cleaning the deblocked spectacle lenses L and the block pieces B.

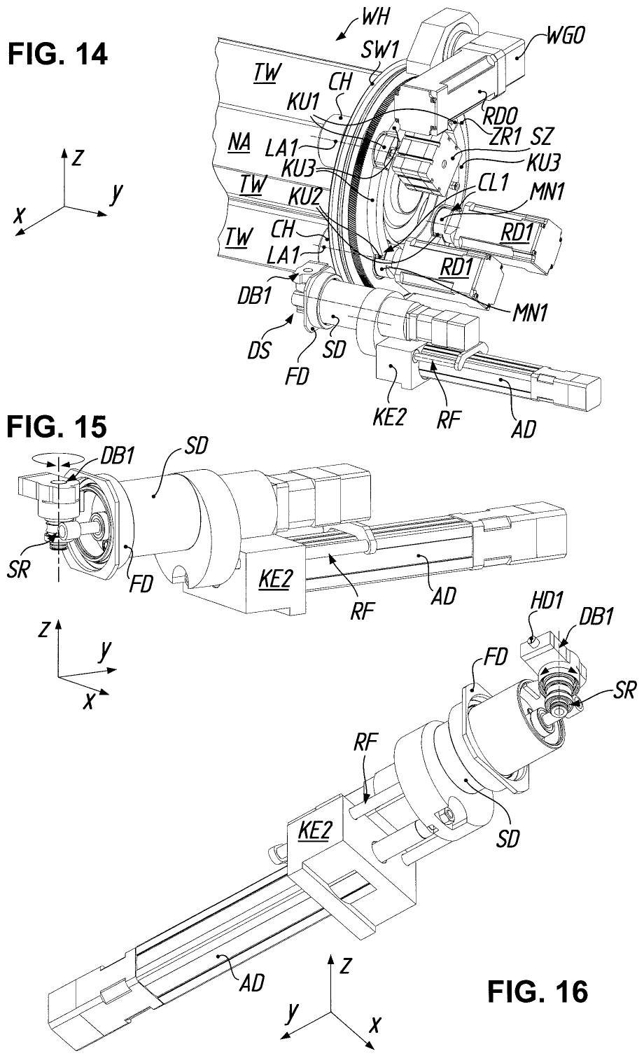

According to, in particular, FIGS. 5, 12 and 14 to 16 the deblocking station DS comprises, as a first treatment device, a first nozzle subassembly DB1 with a first high-pressure nozzle HD1 for delivery of a high-pressure pressure medium jet for deblocking of the spectacle lenses L from the respectively associated block piece B. As will be explained later with reference to FIGS. 14 to 16, the first nozzle subassembly DB1 is movably mounted on the machine frame MG so that the first high-pressure nozzle HD1 is settable in situ in its axial position and its adjustment angle with respect to a blocked spectacle lens L held in the deblocking station DS by the workpiece holding arrangement WH.

According to, in particular, FIGS. 5 and 12 the cleaning station CS comprises, as a second treatment device, a second nozzle subassembly DB2 with a second high-pressure nozzle HD2 for delivery of a high-pressure pressure medium jet for cleaning the deblocked spectacle lenses L. As can be similarly inferred from FIGS. 5 and 12, the cleaning station CS further comprises, as a third treatment device, a third nozzle subassembly DB3 with a third high-pressure nozzle HD3 for delivery of a high-pressure pressure medium jet for cleaning the block pieces B. The high-pressure nozzles HD2 and HD3 of the cleaning station CS are mounted in fixed location with respect to the machine frame MG, although a limited manual adjustment possibility of the high-pressure nozzles HD2 and HD3 is provided in order to direct them onto the deblocked spectacle lens L or block piece B, which is held in the workpiece holding arrangement WH.

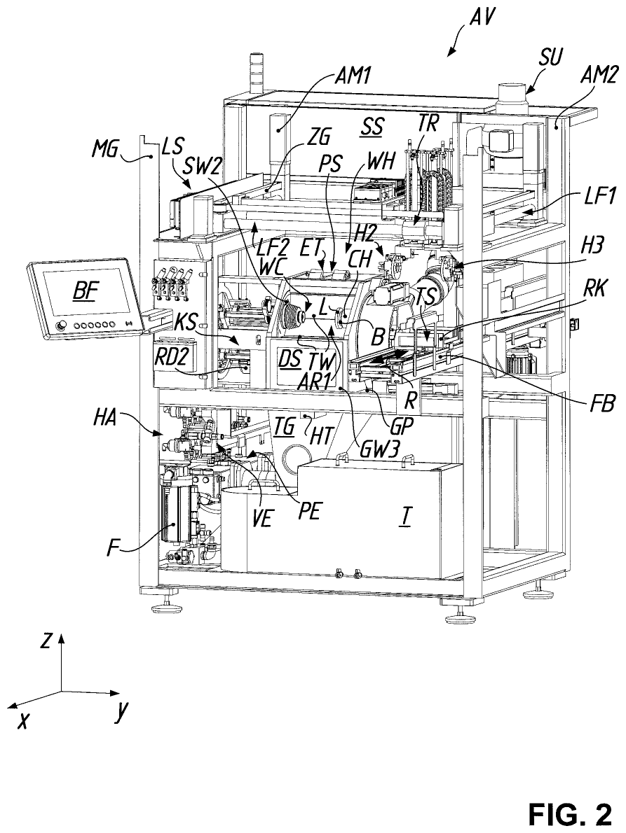

The hydraulic supply of the nozzle subassemblies DB1, DB2, DB3 is carried out by way of a hydraulic arrangement HA which, according to FIGS. 1 and 2, is mounted on the machine frame MG in a lower region, laterally below the workpiece holding arrangement WH. This hydraulic arrangement HA generally comprises a pump unit PE, by which temperature-controlled water as pressure medium can be conveyed from a tank T by way of a distributor device VE of the hydraulic arrangement HA to the nozzle subassemblies DB1, DB2, DB3. In addition, connected with the hydraulic arrangement HA are low-pressure nozzles ND1 and ND2 which, according to FIGS. 5 and 12, are associated with the deblocking station DS and the cleaning station CS in order to deliver a low-pressure pressure medium jet for cleaning the respective station DS, CS.

The hydraulic arrangement HA is the subject of parallel German Patent Application DE 10 2019 006 505.0, i.e. filed with the same application date, under the title “Hydraulic arrangement for a device for deblocking optical workpieces, particularly spectacle lenses, from associated block pieces”, to which, for the avoidance of repetition, express reference may be made at this point with respect to the more specific construction and function of the hydraulic arrangement HA.

Arranged at approximately the same height as the workpiece holding arrangement WH and on the right in FIGS. 1 and 2 adjacent to the workpiece holding arrangement WH is a transfer station TS for deposit of spectacle lenses L blocked on block pieces B, deblocked spectacle lenses L and block pieces B. In the illustrated embodiment the transfer station TS of the deblocking device AV comprises a conveyor belt FB, which is mounted on the machine frame MG, for transport of job trays RK in a transport direction R. The job trays RK serve for reception of spectacle lenses L blocked on block pieces B, deblocked spectacle lenses L and block pieces B.

Mounted above the workpiece holding arrangement WH and the transfer station TS at the machine frame MG is a loading system LS by which the spectacle lenses L blocked on block pieces B, deblocked spectacle lenses L and block pieces B can be transported between the transfer station TS and the loading station PS provided at the workpiece holding arrangement WH and placed in or removed from the respective station TS, PS. The loading system LS generally comprises a carrier TR, which is movable in a movement plane x-y by way of two linear guide units LF1, LF2 and which carries three holders H1, H2, H3 movable in a transverse direction z with respect to the movement plane x-y. Of these, a first holder H1 (concealed in FIGS. 1 and 2) is assigned to the spectacle lenses L blocked on block pieces B, a second holder H2 is assigned to the deblocked spectacle lenses L and a third holder H3 is assigned to the block pieces B. A feature of this loading system LS is that the linear guide units LF1, LF2 are constructed and arranged in the form of an H gantry, with two stationary drive motors AM1, AM2 for drive—in the same sense or in opposite sense—of a traction element ZG, which is movably arranged in an H shape at the linear guide units LF1 and LF2 and is attached to the carrier TR.

The loading system LS is the subject of parallel German Patent Application DE 10 2019 006 503.4, i.e. filed with the same application date, under the title “Loading system for an optical machine, particularly for loading and unloading optical workpieces, such as spectacle lenses, and deblocking device comprising such a loading system”, to which, for the avoidance of repetition, express reference is made at this point with respect to the more specific construction and function of the loading system LS.

In addition, FIGS. 1 and 2 show a control cabinet SS, which is arranged behind the machine frame MG, for the deblocking device AV as well as a suction device SU, which is positioned adjacently on the right and which is connected with the second sub-station PS2 of the loading station PS and the cleaning station CS (the corresponding housing windows can be seen in FIG. 5 in the background to the respective stations). A funnel-shaped housing section TG for collection in common of pressure medium, blocking material and other residues for preparation or disposal is arranged, as can be seen in FIGS. 1 to 5 and 7, below the deblocking and cleaning stations DS, CS, which are themselves positioned below the loading station PS for best possible conducting away of the water needed in the process. Finally, a control panel BF, by way of which the deblocking device AV can be controlled, is secured to the machine frame MG at the front left in FIGS. 1 and 2.

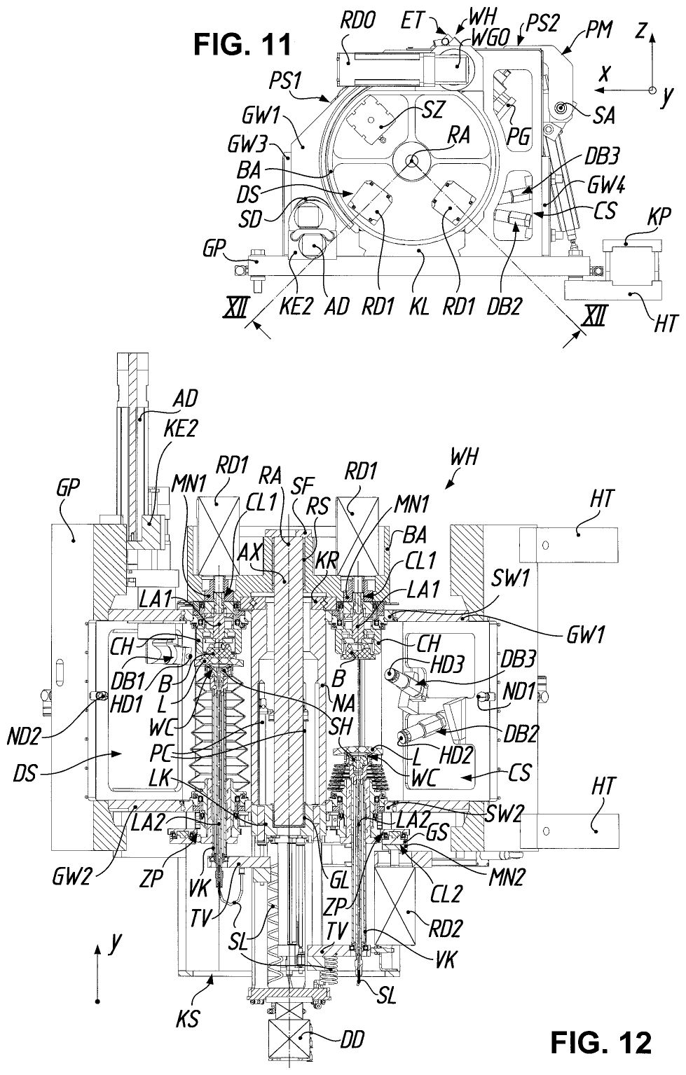

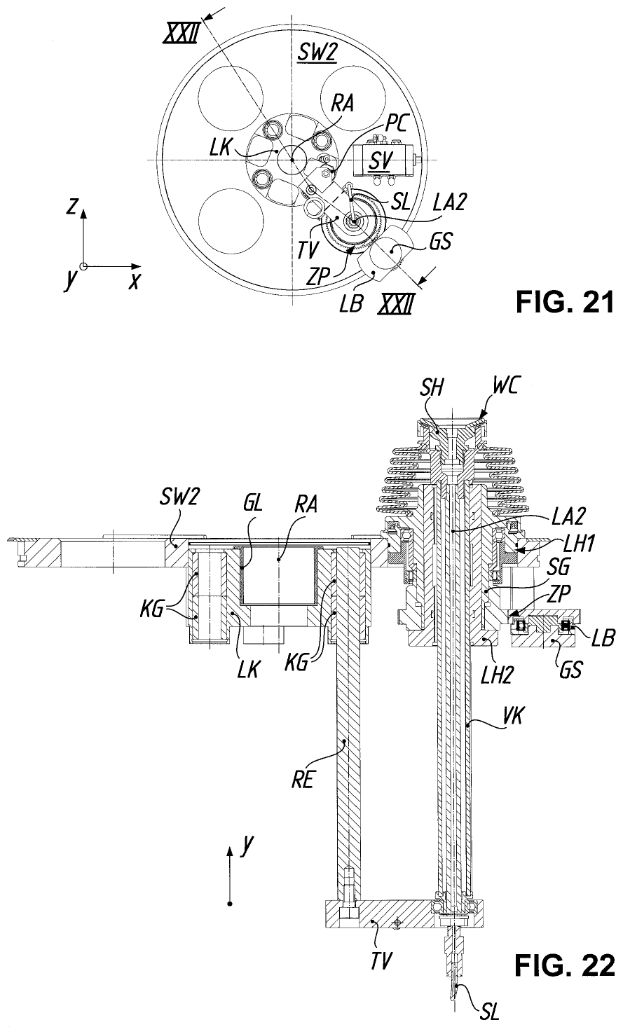

Further details of the workpiece holding arrangement WH can be inferred from FIGS. 5 to 14 and 17 to 22. As firstly shown particularly in FIG. 5, a feature of the workpiece holding arrangement WH is that the workpiece holding arrangement WH comprises a plurality of partition walls TW, which separate and delimit four work spaces AR1, AR2, AR3 and AR4 from one another (also marked in the figures by the respective Roman numerals I, II, Ill and IV applied at the end. In that case, an individual workpiece holder CH, here in each instance in the form of a clamping chuck, is assigned to each work space AR1, AR2, AR3 and AR4 for parallel use for different spectacle lenses L. As will be explained in more detail in the following, the work spaces can be moved together with the workpiece holding arrangement WH with respect to the machine frame MG so that each work space AR1, AR2, AR3 and AR4 can be selectably moved from the loading station PS, which is stationary at the machine frame MG, to the treatment or processing station DS, CS physically spaced from the loading station, and conversely. More precisely, each work space AR1, AR2, AR3 and AR4 can be displaced together with the workpiece holding arrangement WH in a movement cycle (indicated by a central round arrow in FIG. 5) from the first sub-station PS1 of the loading station PS (quadrant at upper right in FIG. 5) via the deblocking station DS (quadrant at lower right), the cleaning station CS (quadrant at lower left) and the second sub-station PS2 of the loading station PS (quadrant at upper left) back to the first sub-station PS1 of the loading station PS so that the work spaces AR1, AR2, AR3 and AR4 can be used simultaneously for different spectacle lenses L and different processes (loading, deblocking, cleaning, unloading).

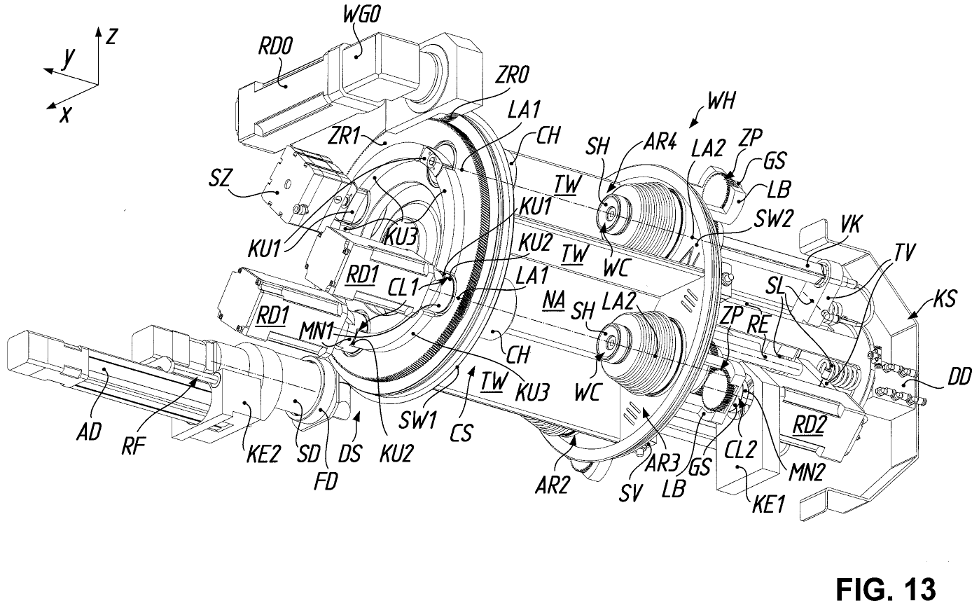

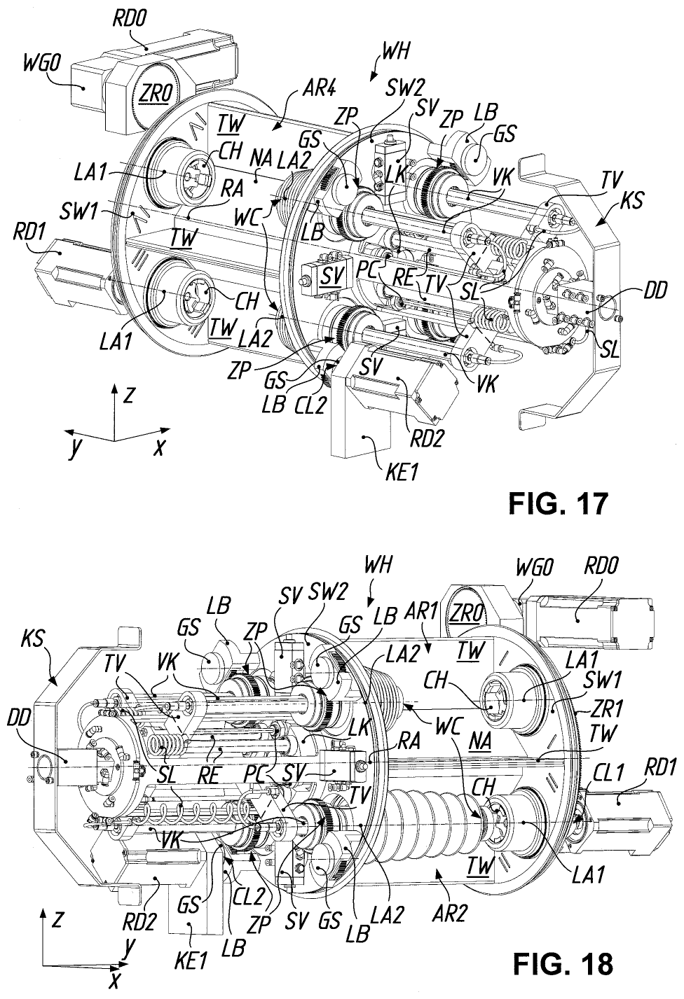

For that purpose, the work spaces AR1, AR2, AR3 and AR4 of the workpiece holding arrangement WH together with their workpiece holders CH are arranged to be rotatable about a common axis RA of rotation. The overall result is a drum-like construction of the workpiece holding arrangement WH, as can be readily seen in FIGS. 13, 17 and 18, with two mutually opposite end walls SW1, SW2, between which the partition walls TW separating the work spaces AR1, AR2, AR3 and AR4 are arranged. In that regard, the axis RA of rotation extends through the mutually parallel end walls SW1, SW2, which according to, in particular, FIGS. 5 and 12 are fixedly connected together by way of a central hub section NA.

Whereas a first end wall SW1 of the workpiece holding arrangement WH of drum-like construction carries the workpiece holders CH, as can be readily seen in FIGS. 17 and 18, a second end wall SW2 of the workpiece holding arrangement WH carries, according to, for example, FIG. 13, workpiece counter-holders WC which are aligned with the workpiece holders CH. This alignment of the workpiece holders CH and the workpiece counter-holders WC, which is effected by way of the accuracy of the production components of the workpiece holding arrangement WH, is always maintained even in the case of exchange of the respective workpiece holder CH or workpiece counter-holder WC. Not only the workpiece holders CH, but also the workpiece counter-holders WC are, in addition, each mounted to be rotatable about the longitudinal axis LA1 or LA2 thereof. In other words, the result is a circular arrangement of four spindle pairs which are uniformly mutually angularly spaced apart around the axis RA of rotation. Moreover, the workpiece counter-holders WC are each axially displaceable along the longitudinal axis LA2 thereof parallel to the axis RA of rotation. In that regard, the workpiece counter-holders WC are each provided at the end thereof projecting into the respective work space AR1, AR2, AR3 and AR4 with a suction head SH for holding the spectacle lens L.

Before further details with respect to the workpiece holders CH and the workpiece counter-holders WC as well as the movement possibilities thereof in relation to the end walls SW1, SW2 are discussed, the rotary drive and rotational mounting of the entire workpiece holding arrangement WH in the machine frame WG shall firstly be explained in more detail. As can be best seen in FIGS. 5 to 11, the deblocking device AV comprises, as carrier, a base plate GP which is screw-connected with the machine frame MG by way of holders HT and clamping plates KP. Mounted on this base plate GP are all components and subassemblies of the stations PS, DS, CS, which are disposed thereabove, and of the workpiece holding arrangement WH of the deblocking device AV. The base plate GP thus predetermines the accuracy of the entire deblocking device AV; the necessary mounting surfaces are all disposed on the same side of the base plate GP and are formed in the same working step. A base BA, which is executed as a rotary part, for the mounting of the workpiece holding arrangement WH is screw-connected with the base plate GP by way of a block KL. Equally, a housing for the workpiece holding arrangement WH is secured to the base plate GP, which housing has, inter alia, a first housing wall GW1 associated with the movable first end wall SW1 of the workpiece holding arrangement WH and a second housing wall GW2 associated with the movable second end wall SW2 of the workpiece holding arrangement WH. Each of the housing walls GW1 and GW2 is provided with a central, round opening in which the respective round end wall SW1, SW2 of the workpiece holding arrangement WH is received to be rotatable and suitably sealed relative to the corresponding housing wall GW1, GW2 (see FIG. 12).

According to FIG. 12, the workpiece holding arrangement WH is rotatably mounted, by its central hub section NA, on the base BA at one side by way of a cross-roller bearing KR. In that regard, an outer ring of the cross-roller bearing KR is screw-connected with the base BA and an inner ring of the cross-roller bearing KR is screw-connected with the hub section NA. In addition, disposed in the center of the hub section NA is an axle AX which serves for additional support of the workpiece holding arrangement WH. The axle AX is secured to the base BA by a clamping flange SF and an annular spring clamping element RS. The workpiece holding arrangement WH can be supported on the axle AX by way of a slide bearing GL at the end of the axle AX remote from the base BA.

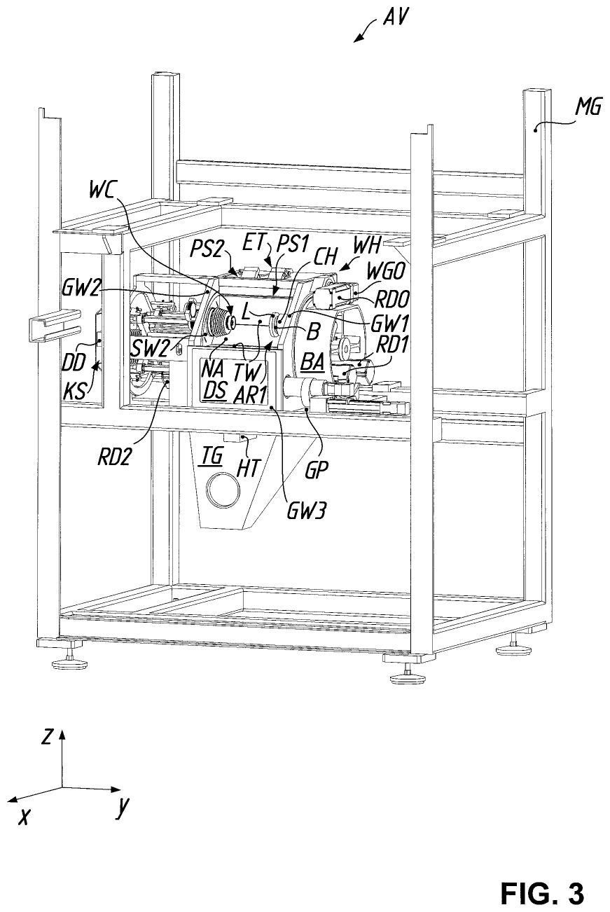

According to, in particular, FIGS. 3, 4, 6 and 7 a servomotor RD0 with an angle transmission WG0 is provided for rotary drive of the workpiece holding arrangement WH about the axis RA of rotation, the servomotor being secured to the base BA at the top. As FIGS. 13, 14, 17 and 18 illustrate, the angle transmission WG0 drives a helically toothed gearwheel ZR0, which meshes with a larger helically toothed gearwheel ZR1. The latter is secured on the side remote from the work spaces AR1, AR2, AR3 and AR4 to the first end wall SW1 of the workpiece holding arrangement WH. A very high transmission ratio (for example 1:275) is provided at this place so as to achieve a moment-of-inertia ratio (approximately 1:25) with which rapid movements and precise positionings of the workpiece holding arrangement WH are possible.

The workpiece holders CH of the workpiece holding arrangement WH can be driven to rotate about the longitudinal axis LA1 thereof, for which purpose a respective rotary drive RD1 is associated with each of the deblocking station DS and the cleaning station CS. The two rotary drives RD1 are mounted in fixed position at the machine frame MG, more precisely flange-mounted on the base BA connected therewith, and can be drivingly connected by a clutch CL1 with that workpiece holder CH which is present in or at the respective station DS, CS.

Details with respect thereto can be inferred from, in particular, FIGS. 6, 13 and 14. Accordingly, the clutches CL1 are mechanically positive clutches. These are each formed by a curved sliding block KU1 and a sliding groove KU2 formed to be complementary thereto. Whereas the sliding block KU1 together with the respective workpiece holder CH can rotate with respect to the first end wall SW1 of the workpiece holding arrangement WH about the longitudinal axis LA1, the sliding groove KU2 is provided in an entrainer MN1 which is connected with the respective rotary drive RD1 and which, according to FIG. 6, engages through a respectively associated round opening in the base BA. The guide is completed by correspondingly curved sliding elements KU3, which have the shape of a segment of a ring and which as seen in circumferential direction are secured between the sliding blocks KU1 to the first end wall SW1. The sliding blocks KU1 are guided, like the sliding elements KU3, in an annular groove KU4 of the base BA, as FIG. 6 shows, which is interrupted merely by the openings for reception of the entrainers MN1.

It will be apparent to the expert that an annular encircling guide track is the overall result. If the workpiece holding arrangement WH is disposed in an angular position about the axis RA of rotation in which the workpiece holders CH have not yet reached or have already left the respective position thereof in the stations LS1, DS, CS or LS2 of the deblocking device AV, then the entrainers MN1 of the rotary drives RD1 are (angularly) guided by way of the sliding elements KU3, whilst the sliding blocks KU1 at the workpiece holders CH are (angularly) guided in the annular groove KU4 of the base BA. On reaching the work position at the respective rotary drive RD1 the sliding block KU1 of the corresponding workpiece holders CH is pivoted into the sliding groove KU2 at the entrainer MM1 of the respective rotary drive RD1 and thus engages the clutch CL1. For further pivotation of the workpiece holding arrangement WH about the axis RA of rotation, the respective rotary drive RD1 is, of course, to be so positioned in rotational angle by its entrainer MN1 that an encircling guide track again results so that the clutch CL1 can disengage and further rotational movement of the workpiece holding arrangement WH is not obstructed.

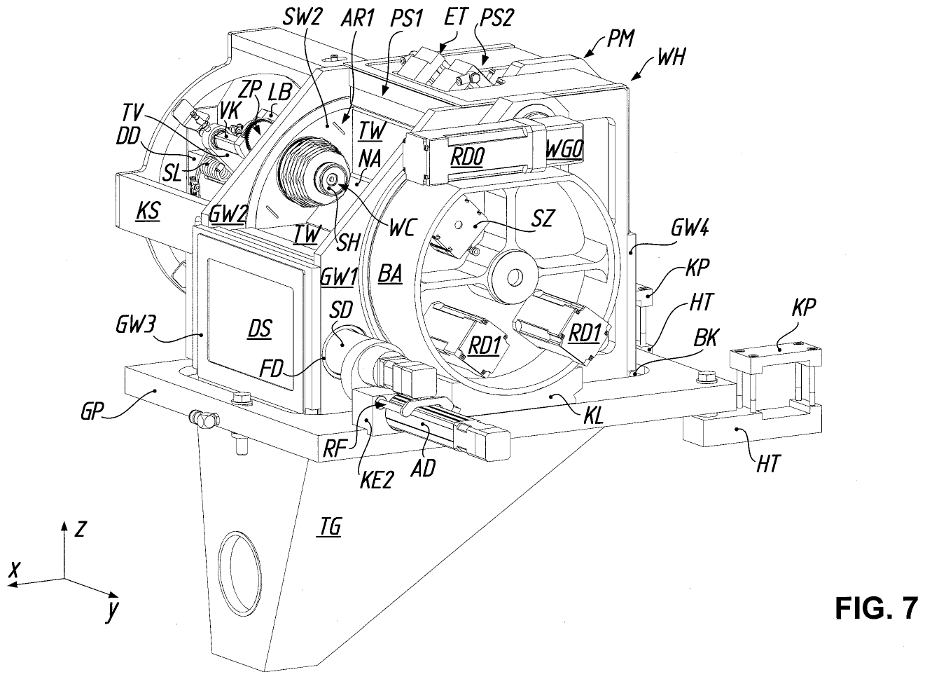

Finally, a clamping chuck cylinder SZ is flange-mounted, as FIGS. 7, 11, 13 and 14 show, on the base BA in the region of the sub-station PS1 for loading of spectacle lenses L, which are blocked on block pieces B, prior to deblocking and for unloading block pieces B after deblocking. The clamping chuck cylinder SZ can be actuated pneumatically so as to open and close the clamping chuck at the respective workpiece holder CH in a manner known per se.

The workpiece counter-holders WC of the workpiece holding arrangement WH can also be driven for rotation about the longitudinal axis LA2 thereof, for which purpose a rotary drive RD2 is associated with the cleaning station CS. The rotary drive RD2 is mounted on the machine frame MG in fixed location, more precisely secured to the base plate GP—which is connected therewith—by a bracket KE1. The rotary drive RD2 can be drivingly connected by a clutch CL2 with that workpiece counter-holder WC which is then present at the cleaning station CS.

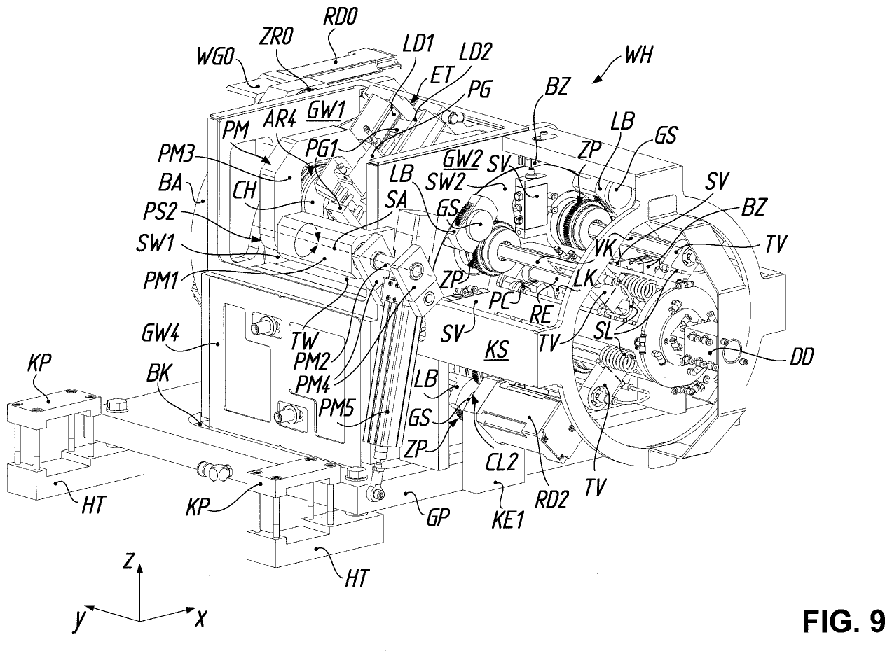

Details with respect thereto can be inferred from, in particular, FIGS. 9, 10, 12, 13, 17 and 18. In order to create space near the axis RA of rotation of the workpiece holding arrangement WH for the axial adjustment possibility of the workpiece counter-holders WC as already mentioned above and still to be described in the following, the rotary drive RD2 for the cleaning station CS is mounted on the base plate GP by way of the bracket KE1 to be radially offset. The clutch CL2 is here a force-locking clutch, namely a magnetic clutch, which has a magnetic entrainer MN2 at the drive side. Transmission of torque takes place via an air gap from the entrainer MN2 to a respective metallic counterpart GS at the second end wall SW2. On rotation of the workpiece holding arrangement WH about the axis RA of rotation the respective counterpart GS of the magnetic clutch CL2 simply pivots under the entrainer MN2 of the rotary drive RD2, whereby the clutch CL2 is engaged. Disengagement takes place by pivotation of the respective counterpart GS away from the opposite position with the entrainer MN2 in the case of a further rotation of the workpiece holding arrangement WH about the axis RA of rotation.

The respective counterpart GS for the clutch CL2 is rotatably mounted, together with a first gearwheel of a gearwheel pair ZP, on a bearing block LB, which is secured to the second end wall SW2. As shown in, in particular, FIGS. 17 and 18, four corresponding bearing blocks LB are thus uniformly distributed over the circumference and secured to the second end wall SW2 respectively in association with the work spaces AR1, AR2, AR3 and AR4 of the workpiece holding arrangement WH. Rotational drive of the workpiece counter-holders WC takes place by way of the respective gearwheel pair ZP when the corresponding work space AR1, AR2, AR3 and AR4 is present at the cleaning station CS. For that purpose, as can be best seen in FIG. 22, the second gearwheel of the gearwheel pair ZP is secured to a spindle housing SG for the workpiece counter-holders WC, which for its part is rotatably mounted by a (rotary) bearing arrangement in a bearing flange LH1 mounted on the second end wall SW2.

FIG. 22 also shows that for linear guidance of the individual workpiece counter-holders WC relative to the second end wall SW2 there is provided a respective slide-bearing linear guide with a bearing flange LH2, which is fixedly mounted in the spindle housing SG and in which an aluminum square tube VK is linearly guided and mounted by way of a (linear) guide arrangement. As a result, the square tube VK is also secured against rotation relative to the bearing flange LH2. The afore-mentioned suction head SH of the workpiece counter-holder WC is attached to the respective square tube VK by way of an intermediate member.

A round-rod guide with ball bushings KB is mounted, as a further linear guide, for each workpiece counter-holder WC in parallel with the afore-described slide-bearing linear guide. This further linear guide comprises a respective round rod RE which is fixedly connected with the respective square tube VK by way of a cross member TV and which according to FIG. 22 is mounted in a central bearing member LK of the workpiece holding arrangement WH by way of two respective ball bushings KB. The central bearing member LK is fixedly connected with the second end wall SW2 and the central hub section NA of the workpiece holding arrangement WH and, according to FIGS. 12 and 22, also carries the afore-mentioned slide bearing GL of the workpiece holding arrangement WH. Tipping of the workpiece counter-holders WC relative to the second end wall SW2 is counteracted by the thus-produced combined linear guidance (slide-bearing linear guide and round-rod guide).

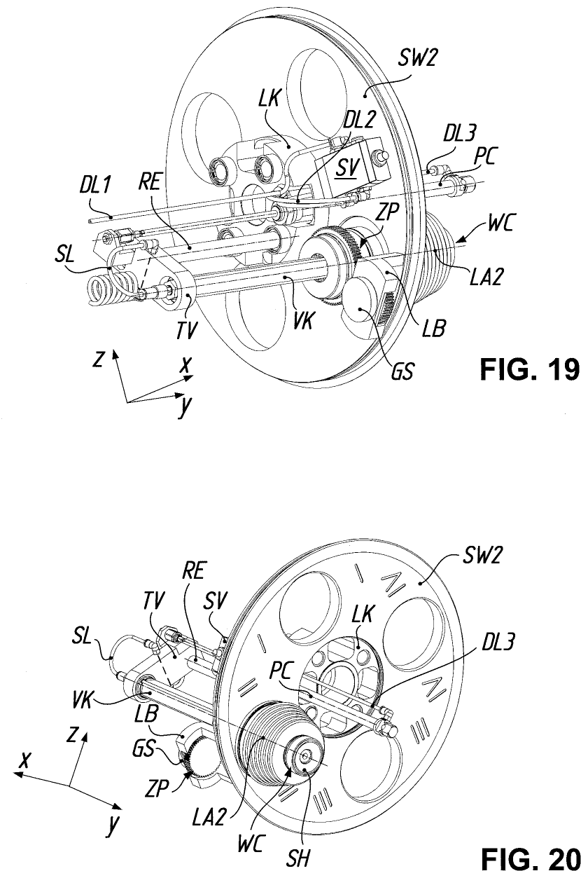

As FIGS. 19 and 20, in particular, show, the workpiece counter-holders WC of the workpiece holding arrangement WH are axially displaceable independently of one another by a respectively associated pneumatic cylinder. In that regard, the respective pneumatic cylinder PC is fixedly mounted on the bearing member LK in the second end wall SW2 and projects by its cylinder housing in parallel arrangement to the afore-described linear guides into the central hub section NA of the workpiece holding arrangement WH. A piston rod of the respective pneumatic cylinder PC is secured by its end, which is remote from the cylinder housing, to the cross-member TV.

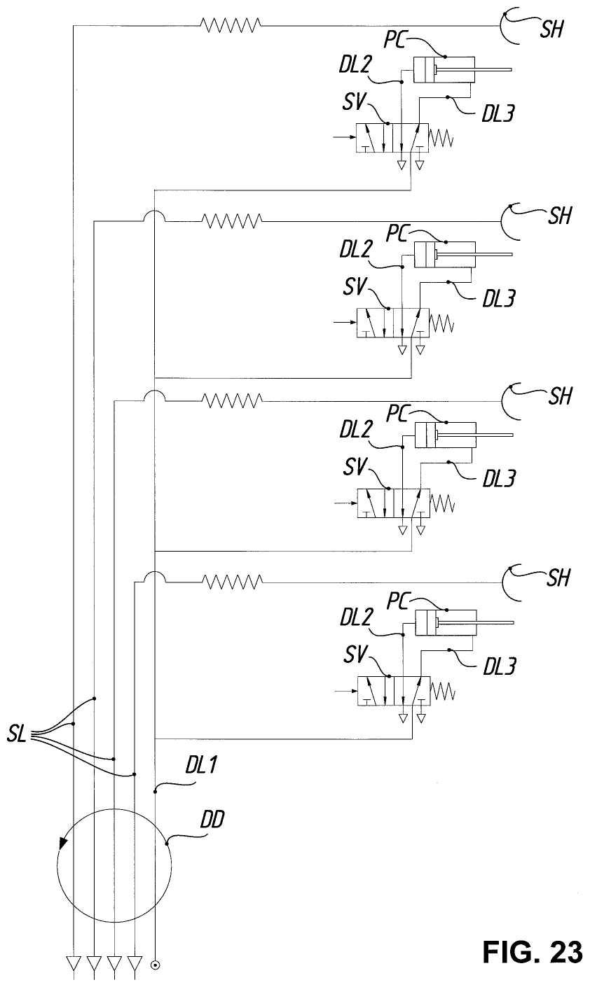

For pneumatic activation of the pneumatic cylinders PC, which here are executed as double-acting cylinders, there is associated with each pneumatic cylinder PC a switching valve SV which in the illustrated embodiment is constructed as a plunger-actuated monostable 5/2-way valve (see also FIG. 23). As FIGS. 17 and 18, in particular, show, four corresponding switching valves SV are thus distributed uniformly over the circumference and secured from outside to the second end wall SW2 in respective association with the work spaces AR1, AR2, AR3 and AR4 of the workpiece holding arrangement WH.

In the valve basic setting each switching valve SV is so switched by spring bias that the pneumatic cylinder PC executes a movement into the rear cylinder end position (“retraction”). This valve setting is necessary for, for example, the deblocking station DS so as to pull the spectacle lens L thereat from the block piece B when vacuum prevails at the suction head SH, for which purpose, for example, a drawing-off force of approximately 30 N is required. If the switching valve SV is switched, the respective pneumatic cylinder PC then moves the workpiece counter-holder WC, which is connected therewith, forwardly in the direction of the opposite workpiece holder CH. Through this valve switching it is possible, for example, in the deblocking station DS to shut off the switching force from the switching valve SV when the vacuum at the suction head SH, which rests on the spectacle lens L to be deblocked, is built up, whereupon the spectacle lens L is drawn away by the pneumatic cylinder PC from the block piece B held at the workpiece holder CH.

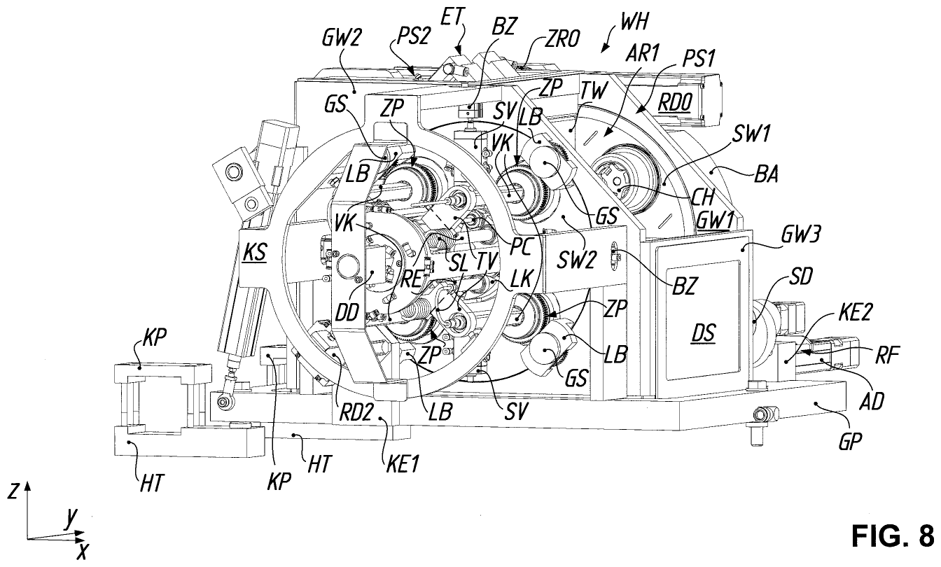

Provided for actuation of the switching valves SV are actuating cylinders BZ which each comprise a plunger for mechanical loading of the switching valves SV with a switching force—indicated in FIG. 23 by actuation arrows at the switching valves SV—and which are mounted in fixed location with respect to the machine frame MG. More precisely, as FIGS. 8 to 10, in particular, show, these actuating cylinders BZ are secured to the second housing wall GW2 of the housing for the workpiece holding arrangement WH and, in fact, above and on either side of the workpiece holding arrangement WH. No actuating cylinder BZ is installed below the workpiece holding arrangement WH. In that case, two of the actuating cylinders BZ are associated with the loading station PS, i.e. one actuating cylinder BZ for the first sub-station PS1 and one actuating cylinder BZ for the second sub-station PS2. Thereagainst, the further actuating cylinder BZ is associated with the deblocking station DS. Only in the cleaning station CS is there no provision of an actuating cylinder BZ. Accordingly, advance of the workpiece counter-holder WC is possible in the stations PS1, PS2 and DS, but by contrast not in the cleaning station CS (see in that regard also FIG. 12).

A pneumatic supply of the pneumatic cylinders PC, which are rotatable together with the second end wall SW2 of the workpiece holding arrangement WH about the axis RA of rotation, and the suction heads SH for the workpiece counter-holders WC of the workpiece holding arrangement WH takes place by way of a common rotary joint DD, which is supported against rotation relative to the machine frame MG. In order to support the rotary joint DD against rotation, the rotary joint DD comprises, particularly according to FIGS. 8 to 10 and 12, a housing which is secured by way of a cage-like support structure KS, which surrounds the afore-described components at the second end wall SW2, to the second housing wall GW2 for the workpiece holding arrangement WH.

In the case of the circuitry, which is provided here, of the pneumatic cylinders PC all switching valves SV can be supplied by way of a common pressure connection, whereas for the four suction heads SH at the workpiece counter-holders WC four sub-atmospheric pressure connections, which are to be controlled separately, are needed, as schematically illustrated in FIG. 23. It is thus possible to install a commercially available rotary joint DD with only five channels. As shown in FIGS. 19, 20 and 23, a pressure line DL1 leads from the rotary joint DD to the inlet of each switching valve SV, the two outlets of which are connected by way of pressure lines DL2, DL3 each to a respective side of the pneumatic cylinder PC concerned. In addition, a respective suction line SL runs from the rotary joint DD to the suction head SH of each workpiece counter-holder WC.

In the illustrated embodiment each suction line SL has a helical hose section so as to be able to follow the linear movements of the workpiece counter-holders WC (see, in that respect, FIG. 18). The helical hose section is connected with a through-channel which is formed in each of the cross members TV (illustrated in, in particular, FIGS. 17 to 21 by dashed lines). The through-channel is in turn connected by way of a fixed hose section with a pipe which, according to FIG. 22, runs through the square tube VK of the linear guide and leads to the respective suction head SH.

As already explained further above, the first nozzle subassembly DB1 is movably mounted on the machine frame MG so as to be able to set the axial position and the adjustment angle of the first high-pressure nozzle HD1 even during the deblocking process. Details with respect thereto can be inferred from, in particular, FIGS. 7, 8 and 14 to 16.

Accordingly, a linear drive AD, which is screw-connected with the base plate GP by way of a bracket KE2, is provided for producing an axial movement of the first nozzle subassembly DB1 parallel to the longitudinal axes LA1 of the workpiece holders CH. In the illustrated embodiment, the linear drive AD is an electro-cylinder with stepper motor and transducer feedback, which can be operated as a CNC axis. The linear drive AD is connected, to be effective in terms of actuation, with a carriage SD which is guided by way of a round-rod guide RF with ball bushings at the bracket KE2, as can be best seen in FIG. 16. The carriage SD, which according to FIGS. 5 and 7 projects into the deblocking station DS, passes through an opening in the first housing wall GW1 of the housing for the workpiece holding arrangement WH, wherein a flange seal FD arranged between the carriage SD and the opening seals the deblocking station DS relative to the environment.

At its end projecting into the deblocking station DS the carriage SD carries a worm-wheel transmission SR (see FIGS. 15 and 16) on which the first nozzle subassembly DB1 is flange-mounted and by way of which the angular setting of the first high-pressure nozzle HD1 takes place. The drive of the worm-wheel transmission SR is similarly carried out by a stepper motor with transducer feedback, so that the thus-formed pivot axis can also be operated as a CNS axis. With this angular setting it is possible to precisely aim tangentially onto a boundary layer between spectacle lens L and blocking material or between blocking material and block piece B. The thus-defined point of incidence of the high-pressure jet can also be adjusted by the two CNC axes at the outer contour of the spectacle lens L or of the block piece B during the deblocking.

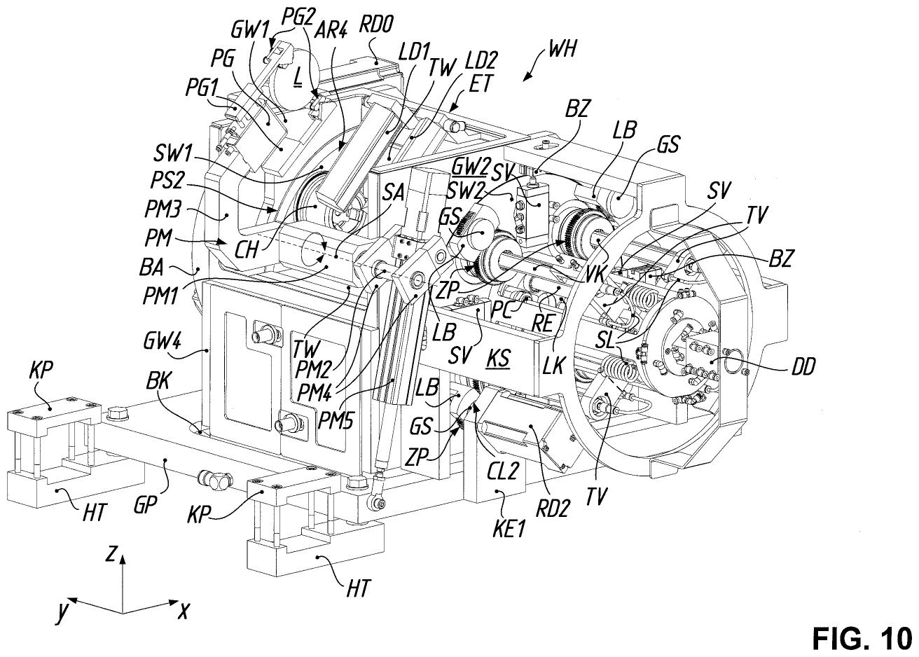

As shown in, in particular, FIGS. 9 and 10, the second sub-station PS2 for unloading deblocked spectacle lenses L after the deblocking comprises a device ET for drying of the deblocked spectacle lenses L as a further treatment device of the deblocking device AV. The drying device ET comprises a workpiece gripper PG, by which a deblocked spectacle lens L can be gripped. In addition, the drying device ET comprises at least one air nozzle LD1, LD2. In the illustrated embodiment, even two air nozzles LD1, LD2 are provided, namely two fan nozzles which are attached at the top to the housing for the workpiece holding arrangement WH. The workpiece gripper PG and the air nozzles LD1, LD2 can be moved relative to one another, so that for drying a deblocked spectacle lens L gripped by the workpiece gripper PG an air flow delivered by the air nozzles LD1, LD2 can be guided over the spectacle lens L.

In the illustrated embodiment the workpiece gripper PG is constructed as a parallel gripper which according to, in particular, FIG. 10 comprises two parallely guided, individually activated gripping finger holders PG1. Each gripping finger holder PG1 carries at the end a rubberized gripping finger pair PG2 which can pivot relative to the gripping finger holder PG1. In order to grip the spectacle lens L the two gripping finger holders PG1 can be moved parallely towards one another. With the thus-constructed parallel gripper it is also possible to grip spectacle lenses L with asymmetrical edge shapes, since the gripping finger pairs PG2 by virtue of the pivotable mounting at the gripping finger holders PG1 can adapt to the edge shape of the deblocked spectacle lenses L.

A pivot mechanism PM, which can best seen in FIGS. 9 and 10, is provided for producing the afore-mentioned relative movement between the workpiece gripper PG and the air nozzles LD1, LD2. The pivot mechanism PM comprises a bearing block PM1, which is mounted on the second housing wall GW2 of the housing for the workpiece holding arrangement WH. A pivot shaft PM2 is mounted in the bearing block PM1 to be pivotable about a pivot axis SA. An angled pivot arm PM3, which at its end remote from the pivot shaft PM2 carries the workpiece gripper PG, is fastened to the end of the pivot shaft PM2 at the left in FIGS. 9 and 10. Two actuating levers PM4 are mounted at the opposite end, which is on the right in FIGS. 9 and 10, of the pivot shaft PM2. An electro-cylinder PM5 with a stepper motor and transducer feedback is pivotably connected with the actuator levers PM4, the piston rod of the electro-cylinder being pivotably connected with the base plate GP.

It will be apparent that through suitable activation of the electro-cylinder PM5 the workpiece gripper PG mounted on a pivot arm PM3 can be pivoted about the pivot axis SA into the second sub-station PS2 of the loading station PS (FIG. 9) or out of the second sub-station PS2 (FIG. 10) in correspondence with the double arrow illustrated in FIGS. 9 and 10.

The following combined removal and drying procedure is thus possible: The workpiece gripper PG is pivoted by the pivot mechanism PM about the pivot axis SA into that work space of the workpiece holding arrangement WH which is then present at the second sub-station PS2 of the loading station PS (FIG. 9). The spectacle lens L held in this work space at the suction head SH of the workpiece counter-holder WC is moved by way of the associated pneumatic cylinder PC with the workpiece counter-holder WC into a transfer position in which the workpiece gripper PG grips the spectacle lens L. After the vacuum prevailing at the suction head SH of the workpiece counter-holder WC has been relieved, the workpiece counter-holder WC is retracted by way of the respective pneumatic cylinder PC and the actual drying of the spectacle lens L can begin. For that purpose the spectacle lens L held by the workpiece gripper PG is pivoted by the pivot mechanism PM slowly past the air nozzles LD1 and LD2. In that case, drying is controlled by way of the speed of pivotation about the pivot axis SA. After the electro-cylinder PM5 of the pivot mechanism PM has reached its end position and thus also the pivot movement about the pivot axis SA has reached an end (FIG. 10), the dried spectacle lens L can be picked up by the loading system LS. Simultaneously with the picking-up of the dried spectacle lens L the workpiece holding arrangement WH further rotates and the next combined removal and drying process can begin.

With respect to the construction of the housing for the workpiece holding arrangement WH the following may be established at this point. According to FIGS. 1 to 5, 7 and 8 the loading system PS is not covered from above, so that the loading system LS can load and unload the deblocking device AV without collisions. In axial direction the first housing wall GW1 and the second housing wall GW2 bound the region of the stations PS, DS and CS in which the work spaces AR1, AR2, AR3 and AR4 of the workpiece holding arrangement WH move. The deblocking station DS is forwardly bounded by a third housing wall GW3, whilst a fourth housing wall GW4 bounds the cleaning station CS to the rear, as FIG. 5, in particular, shows. It can also be readily seen here that the third housing wall GW3 and the fourth housing wall GW4 are each provided with a window so as to afford the operator a view into the respective station DS, CS. According to FIG. 5, only the deblocking station DS, the cleaning station CS and, in part, the second sub-station PS2 of the loading station PS are sealed. Sealing is effected in each instance by a square cord DM of nitrile-butadiene rubber (NBR), which is diagonally clamped and settable in sealing direction. The square cord DM seals on the partition walls TW of the workpiece holding arrangement WH, as shown in FIG. 5. According to FIG. 5, thin discs are provided at the top and back at the second sub-station PS2 of the loading station PS (i.e. at the top and left in FIG. 5). Sealing is not required here, since on the one hand the suction device SU sucks air out of this station and on the other hand the opening for the workpiece gripper PG is not sealed off. Finally, a small basin BK with return channels is formed on the base plate GP (see, in particular, FIG. 5); if water still escapes and runs up to the base plate GP, this can be fed back.

Water is used as process liquid in the deblocking device AV. In this regard, operation can be with, for example, a pressure of approximately 160 bar for the deblocking. For cleaning of the spectacle lenses L and the block pieces B, between 80 bar and 160 bar are used depending on the respective workpiece. Since the water jet also impinges on the optical surfaces of the spectacle lenses L, care has to be taken to ensure that the water is free of particles, which is guaranteed by an external unit (not illustrated) making filtered water with a defined pressure and volume flow available to the deblocking device AV. A water filter F (see FIGS. 1 and 2) provided at the hydraulic inlet of the deblocking device AV can provide an additional safeguard here.

As will be apparent to the expert from the above description of a preferred embodiment of the deblocking device AV, the following (main) process steps i) to v) of a deblocking method are in general carried out in the deblocking device AV for each individual spectacle lens L:
1. Placing a spectacle lens L, which is blocked on a block piece B, in the first sub-station PS1 of the loading station PS of the deblocking device AV as a first handling step i), with seating of the blocked spectacle lens L at the block piece B at or in one of the workpiece holders CH of the workpiece holding arrangement WH;
2. Deblocking of the spectacle lens L from the block piece B in the deblocking station DS of the deblocking device AV by a high-pressure jet, which is delivered by the first high-pressure nozzle HD1 and the orientation of which with respect to the spectacle lens L or the block piece B during deblocking can in a given case be varied, as described above with reference to FIGS. 14 to 16, wherein during this deblocking step ii) the workpiece holder CH holding the block piece B is rotationally driven by the rotary drive RD1 of the deblocking station DS and the spectacle lens L is held by one of the moved-forward workpiece counter-holders WC of the workpiece holding arrangement WH with the suction head SH provided thereat and is withdrawn from the block piece B (see, with respect thereto, also FIG. 12, on the left);
3. Cleaning the deblocked spectacle lens L and the deblocked block piece B in the cleaning station CS of the deblocking device AV by high-pressure jets delivered by the second high-pressure nozzle HD2 (for the spectacle lens L) or the third high-pressure nozzle HD3 (for the block piece B), wherein during this cleaning step v) the spectacle lens L held by the retracted workpiece counter-holder WC with the suction head SH and the block piece B held in the opposite workpiece holder CH are rotationally driven by the rotary drives RD1, RD2 provided at the cleaning station CS (see, with respect thereto, also FIG. 12, on the right);
4. Removal of the deblocked spectacle lens L from the second sub-station PS2 of the loading station PS of the deblocking device AV by the moved-forward workpiece counter-holder WC as a second handling step iii), as already described above with reference to FIGS. 9 and 10; and
5. Removal of the block piece B, which is separated from the spectacle lens L, from the first sub-station PS1 of the loading station PS by the workpiece holder CH as a third handling step iv).

In that regard, the above deblocking step ii), the cleaning step v) and the second handling step iii) are performed simultaneously for different spectacle lenses L or block pieces B, wherein the respective deblocked spectacle lens L is advantageously dried at the same time in the second handling step iii), as already described above with reference to FIGS. 9 and 10. The first and third handling steps i) and iv) take place in parallel therewith, but these in sequential manner with respect to one another, because in the first sub-station PS1 of the loading station PS the deblocked block piece B initially has to be removed from the respective workpiece holder CH before a new blocked spectacle lens L at its block piece B can be inserted into the workpiece holder CH. This simultaneous elapsing of the different process steps is made possible by the workpiece holding arrangement WH, which is rotatable about the axis RA of rotation, with its identically equipped work spaces AR1, AR2, AR3 and AR4, which in that case is moved in a movement cycle from station to station at the machine frame MG. It is thus possible to increase the throughput of deblocked spectacle lenses L to, for example, 250 spectacle lenses L per hour.

An optical machine for treatment and/or processing optical workpieces such as spectacle lenses, comprises a machine frame at which a workpiece holding arrangement is movably mounted and at least two treatment and/or processing devices for treatment and/or processing a workpiece held in the workpiece holding arrangement are mounted. The workpiece holding arrangement has a plurality of partition walls which separate at least three work spaces from one another and bound them, the work spaces being movable by the workpiece holding arrangement to the treatment and/or processing devices. A workpiece holder is associated with each work space for parallel use of the work spaces for different workpieces. In use as a deblocking device, each work space is displaceable together with the workpiece holding arrangement with respect to the machine frame in a movement cycle from a loading station fixed in location at the machine frame, via stationary deblocking and cleaning stations, which are physically spaced from the loading station and comprise treatment and/or processing devices, back to the loading station, so that the work spaces are simultaneously usable for different workpieces and different processes.

### REFERENCE NUMERAL LIST

AD linear drive for first nozzle subassembly
AM1 first drive motor of the loading system
AM2 second drive motor of the loading system
AV deblocking device
AR1 first work space of the workpiece holding arrangement
AR2 second work space of the workpiece holding arrangement
AR3 third work space of the workpiece holding arrangement
AR4 fourth work space of the workpiece holding arrangement
AX axle of the workpiece holding arrangement
B block piece
BA base for workpiece holding arrangement
BF control panel of the deblocking device
BK basin in base plate
BZ actuating cylinder for switching valve
CH workpiece holder of the workpiece holding arrangement
CL1 clutch for workpiece holder
CL2 clutch for workpiece counter-holder
CS cleaning station of the deblocking device
DB1 first nozzle subassembly in deblocking station
DB2 second nozzle subassembly in cleaning station
DB3 third nozzle subassembly in cleaning station
DD rotary joint for workpiece holding arrangement
DL1 pressure line to the switching valve
DL2 pressure line to the pneumatic cylinder
DL3 pressure line to the pneumatic cylinder
DM sealing cord for housing sealing
DS deblocking station of the deblocking device
ET device for drying in loading station
F filter of the hydraulic arrangement
FB conveyor belt of the deblocking device
FD flange seal for nozzle adjustment
GL slide bearing for workpiece holding arrangement
GP base plate for workpiece holding arrangement
GS counterpart for magnetic clutch
GW1 first housing wall for workpiece holding arrangement
GW2 second housing wall for workpiece holding arrangement
GW3 third housing wall for workpiece holding arrangement
GW4 fourth housing wall for workpiece holding arrangement
H1 first holder of the loading system
H2 second holder of the loading system
H3 third holder of the loading system
HA hydraulic arrangement of the deblocking device
HD1 first high-pressure nozzle in deblocking station
HD2 second high-pressure nozzle in cleaning station
HD3 third high-pressure nozzle in cleaning station
HT holder for base plate
KB ball bushing of the linear guide of workpiece counter-holder
KE1 bracket for rotary drive of cleaning station
KE2 bracket for linear drive of nozzle adjustment
KL block for base
KP clamping plate for base plate
KR cross-roller bearing for workpiece holding arrangement
KS support structure for rotary joint
KU1 sliding block for clutch of workpiece holder
KU2 sliding groove for clutch of workpiece holder
KU3 sliding element for clutch of workpiece holder
KU4 annular groove for clutch of workpiece holder
L optical workpiece/spectacle lens
LA1 longitudinal axis of the workpiece holder
LA2 longitudinal axis of the workpiece counter-holder
LB bearing block for counterpart of clutch of workpiece counter-holder
LD1 air nozzle of the drying device
LD2 air nozzle of the drying device
LF1 first linear guide unit of the loading system
LF2 second linear guide unit of the loading system
LH1 bearing flange for rotary mounting of workpiece counter-holder
LH2 bearing flange for linear mounting of workpiece counter-holder
LK bearing block of workpiece holding arrangement
LS loading system of the deblocking device
MG machine frame of the deblocking device
MN1 entrainer at clutch of workpiece holder
MN2 entrainer at clutch of workpiece counter-holder
NA hub section of the workpiece holding arrangement
ND1 first low-pressure nozzle for cleaning station
ND2 second low-pressure nozzle for deblocking station
PC pneumatic cylinder for workpiece counter-holder
PE pump device of the hydraulic arrangement
PG workpiece gripper in second sub-station for unloading
PG1 gripping finger holder of the workpiece gripper
PG2 gripping finger pair of the workpiece gripper
PM pivot mechanism for workpiece gripper
PM1 bearing block of the pivot mechanism
PM2 pivot shaft of the pivot mechanism
PM3 pivot arm of the pivot mechanism
PM4 actuating lever of the pivot mechanism
PM5 electro-cylinder of the pivot mechanism
PS loading station of the deblocking device
PS1 first sub-station of the loading station
PS2 second sub-station of the loading station
R transport direction of the conveyor belt
RA axis of rotation of the workpiece holding arrangement
RD0 servomotor for workpiece holding arrangement
RD1 rotary drive for workpiece holder
RD2 rotary drive for workpiece counter-holder
RE round rod of the linear guide of workpiece counter-holder
RF round-rod guide for nozzle adjustment
RK job tray
RS annular spring clamping element for axle
SA pivot axis of the pivot mechanism
SD carriage for nozzle adjustment
SF clamping flange for axle
SG spindle housing for workpiece counter-holder
SH suction head at workpiece counter-holder
SL suction line for the suction head of workpiece counter-holder
SR worm-wheel transmission for nozzle adjustment
SS control cabinet of the deblocking device
SU suction device of the deblocking device
SV switching valve for pneumatic cylinder
SZ clamping chuck cylinder for workpiece holder
SW1 first end wall of the workpiece holding arrangement
SW2 second end wall of the workpiece holding arrangement
T tank for hydraulic arrangement
TG funnel-shaped housing section
TR carrier/y carriage of the loading system
TS transfer station of the deblocking device
TV cross member of the linear guide of workpiece counter-holder
TW partition wall of the workpiece holding arrangement
VE distributor device of the hydraulic arrangement
VK square tube of the linear guide of workpiece counter-holder
WC workpiece counter-holder of the workpiece holding arrangement
WG0 angle transmission for rotary drive of workpiece holding arrangement
WH workpiece holding arrangement of the deblocking device
ZG traction element of the loading system
ZP gearwheel pair for workpiece counter-holder
ZR0 gearwheel for workpiece holding arrangement
ZR1 gearwheel for workpiece holding arrangement
x length direction
y width direction
z height direction

What is claimed is:

1. An optical machine (AV) for the treatment and/or processing of optical workpieces (L), particularly spectacle lenses, comprising having a machine frame (MG), a workpiece holding arrangement (WH) movably mounted on the machine frame (MG) and at least two treatment and/or processing devices (DB1, DB2, DB3), which are mounted on the machine frame (MG), for treatment and/or processing of an optical workpiece (L) held in the workpiece holding arrangement (WH),
characterized in that the workpiece holding arrangement (WH) comprises a plurality of partition walls (TW), which separate and delimit at least three work spaces (AR1, AR2, AR3, AR4) from one another and to each of which a respective workpiece holder (CH) for parallel use for different optical workpieces (L) is assigned,
wherein the work spaces (AR1, AR2, AR3, AR4) are movable together with the workpiece holding arrangement (WH) with respect to the machine frame (MG) so that each work space (AR1, AR2, AR3, AR4) is selectably displaceable from a loading station (PS) for the optical workpiece (L), which is fixed in location at the machine frame (MG), to the treatment and/or processing stations (DS, CS), which are physically spaced from the loading station and comprise the treatment and/or processing devices (DB1, DB2, DB3), and conversely.

2. An optical machine (AV) according to claim 1, characterized in that the workpiece holders (CH) of the workpiece holding arrangement (WH) are each mounted to be rotatable about the longitudinal axis (LA1) thereof.

3. An optical machine (AV) according to claim 2, characterized in that the workpiece holders (CH) of the workpiece holding arrangement (WH) are selectably drivable for rotation about the longitudinal axis (LA1) thereof, for which purpose a rotary drive (RD1) is assigned to at least one of the treatment and/or processing stations (DS, CS), the rotary drive being mounted on the machine frame (MG) and drivingly connectible by a clutch (CL1) with that workpiece holder (CH) present in the respective treatment and/or processing station (DS, CS).

4. An optical machine (AV) according to claim 1, characterized in that the work spaces (AR1, AR2, AR3, AR4) of the workpiece holding arrangement (WH) are arranged to be rotatable together with the workpiece holders (CH) about a common axis (RA) of rotation.

5. An optical machine (AV) according to claim 4, characterized in that the workpiece holding arrangement (WH) is of drum-like construction with two mutually opposite end walls (SW1, SW2) between which the partition walls (TW) separating the work spaces (AR1, AR2, AR3, AR4) are arranged, wherein the axis (RA) of rotation runs through the end walls (SW1, SW2).

6. An optical machine (AV) according to claim 5, characterized in that a first end wall (SW1) of the workpiece holding arrangement (WH) carries the workpiece holders (CH).

7. An optical machine (AV) according to claim 5, characterized in that a second end wall (SW2) of the workpiece holding arrangement (WH) carries workpiece counter-holders (WC) aligned with the workpiece holders (CH).

8. An optical machine (AV) according to claim 7, characterized in that the workpiece
counter-holders (WC) of the workpiece holding arrangement (WH) are each mounted to be rotatable about the longitudinal axis (LA2) thereof.

9. An optical machine (AV) according to claim 8, characterized in that the workpiece counter-holders (WC) of the workpiece holding arrangement (WH) are selectably drivable for rotation about the longitudinal axis (LA2) thereof, for which purpose a rotary drive (D2) is assigned to at least one of the treatment and/or processing stations (CS), the rotary drive being mounted on the machine frame (MG) and drivingly connectible by a clutch (CL2) with that workpiece counter-holder (WC) present in the respective treatment and/or processing station (CS).

10. An optical machine (AV) according to claim 7, characterized in that the workpiece counter-holders (WC) of the workpiece holding arrangement (WH) are each displaceable axially along the longitudinal axis (LA2) thereof parallel to the axis (RA) of rotation.

11. An optical machine (AV) according to claim 10, characterized in that the workpiece counter-holders (WC) of the workpiece holding arrangement (WH) are axially displaceable independently of one another by a respectively associated pneumatic cylinder (PC).

12. An optical machine (AV) according to claim 7, characterized in that the workpiece counter-holders (WC) of the workpiece holding arrangement (WH) are each provided at the end thereof projecting into the respective work space (AR1, AR2, AR3, AR4) with a suction head (SH) for holding the optical workpiece (L).

13. An optical machine (AV) according to claim 11, characterized in that apneumatic supply of the pneumatic cylinders (PC) and/or suction heads (SH) for the workpiece counter-holders (WC) of the workpiece holding arrangement (WH), which are rotatable together with the second end wall (SW2) about the axis (RA) of rotation, takes place by way of a common rotary joint (DD) which is supported against rotation relative to the machine frame (MG).

14. An optical machine (AV) according to claim 3, characterized in that in correspondence with the respective treatment or processing requirements the clutch (CL1, CL2) is a mechanically positive clutch (CL1) or a force-locking clutch (CL2).

15. An optical machine (AV) according to claim 1, characterized in that the optical machine (AV) is a deblocking device apparatus for deblocking optical workpieces (L), from associated block pieces (B), comprising:
the loading station (PS) for loading of optical workpieces (L), which are blocked on block pieces (B), prior to the deblocking and/or unloading of deblocked optical workpieces (L) and/or of block pieces (B) after the deblocking,
a deblocking station (DS) as treatment station for deblocking the optical workpieces (L) from the respectively associated block piece (B) and
a cleaning station (CS) as treatment station for cleaning of the deblocked workpieces (L) and/or the block pieces (B),
wherein each work space (AR1, AR2, AR3, AR4) is displaceable together with the workpiece holding arrangement (WH) in a movement cycle from the loading station (PS) via the deblocking station (DS) and the cleaning station (CS) to the loading station (PS) so that the work spaces (AR1, AR2, AR3, AR4) are simultaneously usable for different optical workpieces (L) and different processes.

16. An optical machine (AV) according to claim 15, characterized in that the deblocking station (DS) comprises as first treatment device a first nozzle subassembly (DB1) with a first high-pressure nozzle (HD1) for delivery of a high-pressure pressure medium jet for deblocking of the optical workpieces (L) from the respectively associated block piece (B).

17. An optical machine (AV) according to claim 16, characterized in that the first high-pressure nozzle (HD1) for delivery of a high-pressure pressure medium jet for deblocking the optical workpieces (L) from the respectively associated block piece (B) is settable in situ in its axial position and/or its adjustment angle with respect to a blocked optical workpiece (L) held in the deblocking station (DS) by the workpiece holding arrangement (WH).

18. An optical machine (AV) according to claim 15, characterized in that the cleaning station (CS) has, as second treatment device, a second nozzle subassembly (DB2) with a second high-pressure nozzle (HD2) for delivery of a high-pressure pressure medium jet for cleaning the deblocked workpieces (L) and/or the block pieces (B).

19. An optical machine (AV) according to claim 18, characterized in that the cleaning station (CS) has, as third treatment device, a third nozzle subassembly (DB3) with a third high-pressure nozzle (HD3) for delivery of a high-pressure pressure medium jet for cleaning the block pieces (B) and/or the deblocked workpieces (L).

20. An optical machine (AV) according to claim 15, characterized in that the loading station (PS) comprises a first sub-station (PS1) for loading optical workpieces (L), which are blocked on block pieces (B), prior to the deblocking and for unloading block pieces (B) after the deblocking as well as a second sub-station (PS2) for unloading deblocked optical workpieces (L) after the deblocking.

21. An optical machine (AV) according to claim 20, characterized in that the second substation (PS2) for unloading deblocked optical workpieces (L) after the deblocking comprises, as further treatment device, a device (ET) for drying the deblocked optical workpieces (L).

22. An optical machine (AV) according to claim 21, characterized in that the device (ET) for drying the deblocked optical workpieces (L) comprises a workpiece gripper (PG), by which a deblocked optical workpiece (L) can be gripped, and at least one air nozzle (LD1, LD2), wherein the workpiece gripper (PG) and the air nozzle (LD1, LD2) are movable relative to one another so that for the drying of a deblocked optical workpiece (L) gripped by the workpiece gripper (PG) an air flow delivered by the air nozzle (LD1, LD2) can be conducted over the optical workpiece (L).

23. An optical machine (AV) according to claim 15, characterized in that at least one separate cleaning nozzle (ND1, ND2) for delivery of a low-pressure pressure medium jet for cleaning of the respective station (DS, CS) is associated with the deblocking station (DS) and/or the cleaning station (CS) and/or that a funnel-shaped housing section (TG) for collection in common of pressure medium, blocking material and other residues for preparation or disposal is arranged below the deblocking station (DS) and the cleaning station (CS).

24. A method for deblocking optical workpieces (L), particularly spectacle lenses, from
associated block pieces (B) with the assistance of a deblocking apparatus for deblocking optical workpieces (L), particularly according to claim 15, comprising the following steps:
i) placing an optical workpiece (L), which is blocked on a block piece (B), in the deblocking apparatus as a first handling step,
ii) deblocking the optical workpiece (L) from the block piece (B) in the deblocking apparatus,
iii) removing the deblocked optical workpiece (L) from the deblocking apparatus as
a second handling step, and
iv) removing or taking out the block piece (B), which is separated from the optical workpiece (L), from the deblocking apparatus as a third handling step,
characterized in that the above deblocking step ii) and at least one of the above handling steps i), iii) and iv) are performed simultaneously for different optical workpieces (L) or block pieces (B) and/or
that, after the deblocking step ii) and prior to the handling step iii) and/or iv), the deblocked optical workpiece (L) and/or the block piece (B) is or are subjected to a cleaning step v), wherein the cleaning step v) and at least the deblocking step ii) are performed simultaneously for different optical workpieces (L) or block pieces (B).

25. A method for deblocking optical workpieces (L), from associated block pieces (B) according to claim 24, characterized in that the deblocking step ii) and/or the cleaning step v) is or are carried out with the assistance of at least one high-pressure pressure medium jet and the deblocked optical workpiece (L) is dried at the same time during the handling step iii).
